(19) United States
(12) Patent Application Publication
(10) Pub. No.: US 2007/0252995 A1
(43) Pub. Date: Nov. 1, 2007

(54) Cavity Ring-Down Sensing Apparatus and Methods

(76) Inventor: Andrew Mark Shaw, Exeter Devon (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/593,219

(22) PCT Filed: Mar. 15, 2005
(86) PCT No.: PCT/GB05/50036

§ 371 Date: Jun. 15, 2007

(30) Foreign Application Priority Data
Mar. 15, 2004 (GB) 0405820.2

(51) Int. Cl. G01N 21/00

(52) U.S. Cl. 356/437

(57) ABSTRACT

We describe an evanescent wave cavity-based optical sensor. The sensor comprises an optical cavity including a reflection from one or more totally internally reflecting (TIR) surfaces generating an evanescent wave to provide a sensing function; a light source to optically excite said cavity at least two different wavelengths; and a detector to monitor a ring-down characteristic of said cavity at each of said two wavelengths; and wherein said one or more TIR surfaces are provided with at least two functionalising materials one responsive at each of said wavelengths such that an interaction between a said functionalising material and one or more targets to be sensed is detectable as a change in absorption of a said evanescent wave at a said wavelength.

This invention is generally concerned with apparatus and methods for sensing based upon evanescent-wave cavity ring-down spectroscopy (CRDS), in particular time-resolved and multiplexed sensing techniques. The invention is also concerned with waveguide-based CRDS sensors in which propagation loss in the waveguide is responsive to an external environmental variable, for example temperature or magnetic field strength. The invention is further concerned with apparatus and methods for characterising fibre optic materials and devices based upon CRDS, and with CRDS sensors responsive to fibre optic distortion, such as microbending sensors.

Cavity Ring-Down Spectroscopy is known as a high sensitivity technique for analysis of molecules in the gas phase (see, for example, G. Berden, R. Peeters and G. Meijer, Int. Rev. Phys. Chem., 19, (2000) 565, P. Zalicki and R. N. Zare, J. Chem. Phys. 102 (1995) 2708, M. D. Levinson, B. A. Paldus, T. G. Spence, C. C. Harb, J. S. Harris and R. N. Zare, Chem. Phys. Lett. 290 (1998) 335, B. A. Paldus, C. C. Harb, T. G. Spence, B. Wilkie, J. Xie, J. S. Harris and R. N. Zare, J. App. Phys. 83 (1998) 3991. D. Romanini, A. A. Kachanov and F. Stoeckel, Chem. Phys. Lett. 270 (1997) 538). The CRDS technique can readily detect a change in molecular absorption coefficient of 10⁻⁶ cm⁻¹, with the additional advantage of not requiring calibration of the sensor at the point of measurement since the technique is able to determine an absolute molecular concentration based upon known molecular absorbance at the wavelength or wavelengths of interest. Although the acronym CRDS makes reference to spectroscopy in many cases measurements are made at a single wavelength rather than over a range of wavelengths.

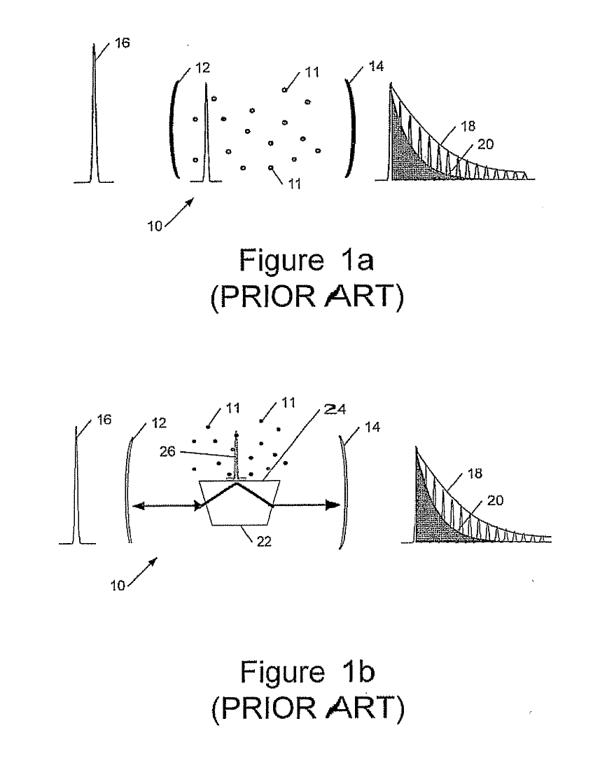

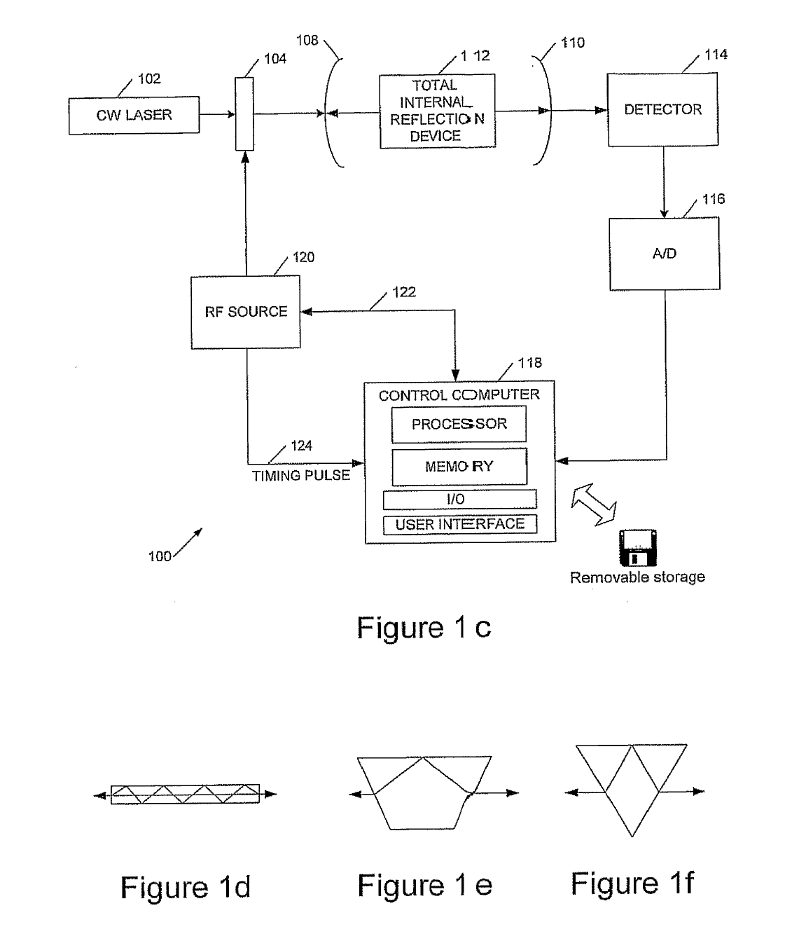

FIG. 1a, which shows a cavity 10 of a CRDS device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, τ. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time τ is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, Δτ, is a function of the strength of absorption of the molecule at the frequency, ν, of interest α(ν) (the molecular extinction coefficient) and of the concentration per unit length, lₛ, of the absorbing species and is given by equation 1 below.
Δτ=tᵣ/{2(1−R)+α(ν)lₛ} (Equation 1)
where R is the reflectivity of each of mirrors 12, 14 and tᵣis the round trip time of the cavity, tᵣ=c/2L where c is the speed of light and L is the length of the cavity. Since the molecular absorption coefficient is a property of the target molecule, once Δτ has been measured the concentration of molecules within the cavity can be determined without the need for calibration.

It will be appreciated that to employ equation 1 measurements of the mirror reflectivities, the molecular absorption (or extinction) coefficient, the cavity length and (where different) the sample lengths are necessary but these may be determined in advance of any particular measurement, for example, during initial set up of a CRDS machine. Likewise since the decay times are generally relatively short, of the order of tens of nanoseconds (although they can be as long as 2 μs with high quality fibre, as described below), a timing calibration may also be needed, although again this may be performed when the apparatus is initially set up.

It will be further appreciated that to achieve a high sensitivity the reflectivities of mirrors 12, 14 should be high (whilst still permitting a detectable level of light to leak out) and typically R equals 0.9999 to provide of the order of 10⁴ bounces. If the total losses in the cavity are around 1% there will only be 3 or 4 bounces and consequently the sensitivity of the apparatus is very much reduced; in practical terms it is desirable to have total losses less than 0.25%, corresponding to around 200 bounces during decay time τ, or approximately 1000 bounces during ring down of the entire cavity.

One problem with CRDS is that the technique is only suitable for sensing molecules that are introduced into the cavity in a gas since if a liquid or solid is introduced into the cavity losses become very large and the technique fails. To address this problem so-called evanescent wave CRDS (e-CRDS) can be employed, as described in the Applicant's co-pending UK patent application no. 0302174.8 filed 30 Jan. 2003. Background prior art relating to e-CRDS can be found in U.S. Pat. No. 5,943,136, U.S. Pat. No. 5,835,231, U.S. Pat. No. 5,986,768, EP1195582A, A. J. Hallock et al. “Use of Broadband, Continuous-Wave diode Lasers in Cavity Ring-Down Spectroscopy for Liquid Samples”, Applied Spectroscopy, 57(5), 2003, 571-573, and D. Romanini et al, “CW cavity ring down spectroscopy”, Chem. Phys. Lett. 264 (1997) 316-322.

FIG. 1b, in which like elements to those of FIG. 1a are indicated by like reference numerals, shows the idea underlying evanescent wave CRDS. In FIG. 1b a prism 22 (as shown, a pellin broca prism) is introduced into the cavity such that total internal reflection (TIR) occurs at surface 24 of the prism (in some arrangements a monolithic cavity resonator may be employed). Total internal reflection will be familiar to the skilled person, and occurs when the angle of incidence (to a normal surface) is greater than a critical angle θ_{c} where sin θ_{c} is equal to n₂/n₁ where n₂ is the refracted index of the medium outside the prism and n₁ is the refractive index of the material of which the prism is composed. Beyond this critical angle light is reflected from the interface with substantially 100% efficiency back into the medium of the prism, but a non-propagating wave, called an evanescent wave (e-wave) is formed beyond the interface at which the TIR occurs. This e-wave penetrates into the medium above the prism but it's intensity decreases exponentially with distance from the surface, typically over a distance of the order of the a wavelength. The depth at which the intensity of the e-wave falls to 1/e (where e=2.718) of it's initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm. In the systems described herein we are particularly concerned with near field sensing, that is at distances <500 nm, <200 nm or <100 nm from the evanescent wave interface ie. generally less than the penetration depth at an operating wavelength, often <50% or <20% of the penetration depth.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules in a gaseous phase. In the configuration of FIG. 1b molecules near the total internal reflection surface 24 are effectively in optical contact with the cavity, and are sampled by the e-wave resulting from the total internal reflection at the surface.

It has been recognised that e-CRDS techniques may be employed to provide sensitive and precise time-resolved sensing; and further that wavelength division multiplexing by be employed to network e-CRDS sensors.

### SUMMARY OF THE INVENTION

According to a first aspect of the present invention there is therefore an evanescent wave cavity-based optical sensor, the sensor comprising: an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function; a light source to inject a pulse of light into said cavity; a detector to detect decaying oscillations of said light pulse within said cavity; and a signal processor coupled to said detector and configured to provide a time-resolved output responsive to a light level within said cavity and having a time-resolution corresponding to a set of said light pulse oscillations, whereby said sensing function operates at substantially said time-resolution.

Depending upon the time resolution of the detector and subsequent signal processing the time resolution of the sensor may correspond to a group of pulses, for example up to five or ten pulses, but preferably the detector and signal processing is sufficiently fast for single pulses to be resolved. In this case the set of light pulse oscillations may comprise a single said light pulse or bounce within the cavity (or a pair of said pulses or bounces). In embodiments of the apparatus the time resolution is substantially determined by the length of the cavity, that is by the round-trip time for an optical pulse bouncing between the mirrors of the cavity.

The TIR surface may be provided with a functionalising material over at least part of its surface such that the evanescent wave interacts with said material. In this way an interaction between said functionalising material and a target to be sensed may be detected as a change in absorption of said evanescent wave. In embodiments the TIR surface is provided with an electrically conducting material over at least part of its surface such that said evanescent wave excites a localised, surface or particle plasmon within said material, for localised, surface or particle plasmon-based e-CRDS sensing. The sensed substance may be biological or non-biological, living or non-living, examples including elements, ions, small and large molecules, groups of molecules, and bacteria and viruses.

The invention also provides a method of performing time-resolved sensing using an optical cavity including a sensing surface, a sensing interaction at said sensing surface modifying an optical ring-down characteristic of said cavity, the method comprising: injecting a pulse of light into said cavity; and monitoring an optical ring-down of said pulse within said cavity to monitor said sensing interaction; and wherein said monitoring is performed substantially on a pulse-by-pulse basis such that said sensing is time-resolved at a resolution of at least an integral number of round trip times of said cavity.

In another aspect the invention provides an evanescent-wave cavity-based optical sensor system, the system comprising: an optical cavity formed by a pair of highly reflective surfaces such that light within said cavity makes a plurality of passes between said surfaces, an optical path between said surfaces including a reflection from one or more totally internally reflecting (TIR) surfaces, a said reflection from a TIR surface generating an evanescent wave to provide an attenuated TIR sensing function; a light source to optically excite said cavity at least two different wavelengths; and a detector to monitor a ring-down characteristic of said cavity at each of said two wavelengths; and wherein said one or more TIR surfaces are provided with at least two functionalising materials one responsive at each of said wavelengths such that an interaction between a said functionalising material and one or more targets to be sensed is detectable as a change in absorption of a said evanescent wave at a said wavelength.

In embodiments the light source and detector employ wavelength division multiplexing technology. Thus in embodiments the optical cavity may comprise a plurality or network of wavelength division multiplexed sensors. A different functionalising material may be provided on each surface, for example to sense (the same or different targets) at a plurality of different locations. Alternatively two or more different functionalising materials may be provided on a single surface (which may be provided at multiple locations within the cavity), for example both responsive to the same target, to provide increased confidence of detection. The different functionalising materials may comprise molecules absorbing differently to one another at different wavelengths, and/or the functionalising material(s) may comprise an electrical conductor to enable surface plasmon-based target detection. Preferably the cavity comprises or includes a fibre optic configured, for example by tapering, to provide a plurality of evanescent wave TIR sensing surfaces (the skilled person will understand that in this context TIR-based sensing involves some attenuation of the TIR).

The invention also provides a method of wavelength division multiplexing sensors of an evanescent wave cavity ring-down sensor system, the method comprising: applying a plurality of different functionalising materials to one or more evanescent wave sensing regions of a cavity of said sensor system, said different functionalising materials having sensing responses at different wavelengths; exciting said cavity at a plurality of different wavelengths corresponding to wavelengths of said sensing responses of said functionalising materials; and monitoring a ring-down characteristic of said cavity at each of said exciting wavelengths.

Use of a fibre optic (FO) cable facilitates the fabrication of inexpensive or even disposable sensing devices. The fibre may be employed for evanescent wave sensing by modifying the fibre, for example removing a portion of the FO surface and/or tapering the FO. By controlling the degree of modification/taper the evanescent field may also be controlled and hence adapted to a particular sensing function or application.

Waveguide Propagation Sensing

It has also been recognised that CRDS techniques employing a cavity including a waveguide such as a fibre optic may be employed to provide sensitive sensors, to provide improvements in fibre optic characterisation techniques, and to provide sensitive sensors responsive to a change in configuration of a fibre optic.

According to a further aspect of the present invention there is therefore provided a waveguide-based cavity ring-down sensor for sensing an environmental variable, the sensor comprising: an optical cavity including a waveguide; a light source for exciting the optical cavity; and a detector for monitoring a ring-down characteristic of the cavity; and a signal processor coupled to said detector and configured to provide a signal output responsive to a change in optical propagation loss within said cavity as determined from said ring-down characteristic; and wherein a change in said environmental variable causes a change in optical propagation loss in said waveguide to provide said signal output.

Preferably the waveguide comprises a fibre optic and in preferred embodiments this is doped to increase the sensitivity of the sensor. The output signal may comprise an electrical output signal or data for a data file.

In a related aspect the invention provides a waveguide-based sensing method for sensing an environmental variable using an optical cavity including a waveguide, the method comprising: determining an optical ring-up or ring-down time for the cavity to determine a cavity loss; and determining a change in said cavity loss from a change in said ring-up or ring-down time, said change in loss being caused by an effect of a change in said environmental variable on said waveguide, to sense said change in said environmental variable.

Use of a fibre optic (FO) cable facilitates the fabrication of inexpensive or even disposable sensing devices. Optionally the fibre may also be employed for evanescent wave sensing by modifying the fibre, for example removing a portion of the FO surface and/or tapering the FO. By controlling the degree of modification/taper the evanescent field may also be controlled and hence adapted to a particular sensing function or application.

According to another aspect of the present invention there is provided fibre optic system characterising apparatus for characterising a fibre optic system using optical ring-down, the apparatus comprising: an optical cavity configurable to include said fibre optic system; a light source for exciting said cavity; a detector for monitoring an optical ring-down of said cavity; and a signal processor coupled to said detector and configured to determine a characteristic of said fibre optic system from said cavity optical ring-down.

The fibre optic system may comprise a fibre optic cable provided with mirrors or a fibre optic coupled into a measuring cavity, or may comprise, for example, a fibre splice or taper. The characteristic may simply comprise the ring-down time but more preferably the characteristic comprises or is expressed as an optical loss; in the latter case the signal processor need not explicitly determine a cavity ring down time In other embodiments, for example where measuring dispersion using pulse shape, the ring down time need not be determined at all.

In a related aspect the invention provides a method of characterising a fibre optic system using optical ring-down, the method comprising: forming an optical cavity including said fibre optic system; exciting said optical cavity using a light source; monitoring a ring-down of said cavity following said excitation; and determining a characteristic of said fibre optic system from said monitoring.

The fibre optic system may comprise a fibre optic cable; this may be a “naked” cable, for example just stepped/graded index silica without any physical protection. Where a fibre manipulation loss such as a bending loss, or a tapering loss, is measured the fibre under investigation may have mirrors added before or after the manipulation/tapering.

According to another aspect of the present invention there is provided a fibre optic sensor, the sensor comprising: an optical cavity including a fibre optic; a light source for exciting the optical cavity; and a detector for monitoring a ring-down characteristic of the cavity; and wherein said fibre optic is configured such that a change in a sensed variable causes a physical change in said fibre optic configuration modifying said ring-down characteristic.

In preferred embodiments the physical change in fibre optic comprises a distortion of the fibre optic, such as a change in length and/or a change in a degree of bending of the fibre. The change is typically (very) small but nevertheless readily detectable using the CRMS technique. In this way the apparatus may be used as a sensitive temperature, pressure, strain or stress measuring instrument or, in a similar way, as a microphone or hydrophone.

In a related aspect the invention provides a method of sensing using distortion of a fibre optic, the fibre optic comprising at least part of an optical cavity, the method comprising: determining an optical ring-up or ring-down time of said cavity; distorting said fibre optic with a sensed variable; and determining a change in said ring-up or ring-down time to sense said distortion.

Use of a fibre optic (FO) cable facilitates the fabrication of inexpensive or even disposable sensing devices. Optionally the fibre may also be employed for evanescent wave sensing by modifying the fibre, for example removing a portion of the FO surface and/or tapering the FO. By controlling the degree of modification/taper the evanescent field may also be controlled and hence adapted to a particular sensing function or application.

The invention also provides an optical cavity such as a fibre optic, as described above. The skilled person will understand that such the optical cavity may be provided without one or both mirrors since these may be provided by the cavity sensing apparatus within which the TIR surface or interface is to operate.

In the previously described sensing systems, and in those described below, polarisation maintaining fibre may advantageously be employed. This facilitates, for example measurement in the plane of the polarization and comparison of the result with another measurement, for example in a different plane or with a measurement from an un-polarised cavity. This may provide, for example, a measure of a dichroic ratio, which may be employed, for example, in the determination of a molecular orientation such as which way up a molecule is bound to the surface. The temporal profiling as described below could allow the re-orientational dynamics to be observed.

Timing Control

Light pulse oscillations comprising a single said light pulse or a pair of pulses or a group or train of pulses may be employed, for example a prepared pulse sequence; a pulse generator may be provided for this purpose.

In each of the various sensor systems and methods described herein temporal profiling of a sensed change may be determined by monitoring the bounce-by-bounce pulse profiles (although without necessarily monitoring every bounce—the monitoring may be punctuated for example to monitor every nth pulse). For example monitoring a bounce-by-bounce change can provide a rate of change of the monitored process or system or a change time-profile, which may provide new information. Applications include, for example, strain temporal profiling (eg. stress-load time profiles) and crack propagation profiling (eg. Information on the rate of propagation of a crack). Such temporal profiling allows the detection of events on rapid timescales of order nanoseconds as compared with, for example, acoustic events on a scale of milliseconds. Moreover because of the rapid optical techniques employed the temporal bandwidth can extend up to >1 MHz, 10 MHz or 1 GHz and, in embodiments can span a range of 3, 4, 5, 6, 7, 8or 9 decades. Monitoring the properties of a fibre with the very low loss sensitivity of the ring-down technique particularly provides useful advantages.

With a fibre optic cable the round-trip time between the pulses can be tuned by varying the length of the fibre and it can become much simpler to measure the activity with the e-field region if the pulses are separated by longer time scales. For example a 1 m cavity has a round-trip time, tr, of 6 ns so the pulses are fairly close to one another. However this scales with length so that a 10 m cavity has a tr that is 60 ns and a 100 in cavity has a tr of 600 ns. Cavities of such lengths, for example >10 m, >50 m or more, are possible within a fibre optic.

With the various sensor systems and methods it is particularly useful, in embodiments, to employ a pump-probe approach. Thus in all the above aspects of the invention a system may be included for providing an optical pump pulse to excite the cavity followed by one or more interrogating pulses, optionally in a pattern, optionally at a different wavelength from the probe pulse (or pulses). These probe pulses can be used to interrogate a photochemical process on the evanescent wave interface, for example in conjunction with a functionalising material on the surface to enhance detection of a target substance, as described in more detail in the applican't co-pending PCT application no. ______ entitled Functionalised Surface Sensing Apparatus And Methods, filed on the same day as this application (hereby incorporated in its entirety by reference). The timing of the probe pulse with respect to the pump may be adjusted by adjusting or selecting the longitudinal position of the taper optionally more than one taper may be employed to provide a plurality of different probe pulse timings for a common pump pulse. The skilled person will appreciate that the flexibility in the pump pulse or pulse sequence employed taken together with this flexibility in probe timing facilitates complex measurements and can potentially enhance target discrimination.

One useful feature of temporal profiling of a sensed change determined by monitoring bounce-by-bounce pulse profiles (which may comprise punctuated monitoring, for example every nth pulse) is the effective localisation of the sample. In the gas phase the sample is everywhere so that sample close to the mirror gets two pulse very close followed by a long gap as the pulses make the trip to the first mirror and back again. This can result in problems as the sample may be excited by the first pulse and then re-interrogated by the second after a very short time interval, in a pump-probe type experiment. The sequence pump-t1-probe-delay-t2-pump-t1-probe is then variable at each place in the cavity. In the (e-)CRDS variation the sample is located at one (or more) particular place (or places) in the cavity. For example if this were the middle the pump-t1-probe-delay-t2-pump-t1-probe sequence would be controlled at 1/2 tr. As the position is moved within the cavity (eg by selecting different taper positions) the timescales t1 and t2 can be tuned for a specific photochemical process

A further refinement is a pump λ1 and probe λ2 configuration where λ1 and λ2 are different. For example λ1 could be in the blue so that it does not bounce in the cavity because the mirrors do not reflect in the blue but the probe pulse at λ2 is at a wavelength at which the mirrors do reflect and can therefore can make multiple probes. This gives a pump-probe-probe-probe-probe sequence with controlled pump and probe time based on the position of the e-field and hence sample within the cavity. A condition may be placed on the pulses that they are shorter than the tr so that the sample only sees substantially one pulse at a time and not at any significant level, say, the top of one pulse and the tail of the preceding pulse at the same time. This can facilitate the interrogation by limiting to one discrete wavelength or a few discrete wavelengths.

Thus in a further aspect the invention provides an evanescent-wave cavity-ring down sensing system, the system comprising: an evanescent-wave optical cavity; an optical pump to provide a pump pulse to said optical cavity at a first wavelength; and an optical probe to provide a probe pulse to said optical cavity at a second wavelength.

Preferably the sensing system comprises at least one pulsed illumination source to provide said pump and probe pulses; preferably one or both of the pump pulse and probe pulse are shorter than an optical round trip time of the cavity. Preferably a loss of the cavity at the first wavelength is such that said pump pulse makes substantially only a single pass of said optical cavity. In preferred embodiments the optical cavity is formed by a pair of highly reflective surfaces such that light within said cavity makes a plurality of passes between said surfaces. Preferably it includes a fibre optic with one or more tapers at a position or positions to select the relative pump-probe timing. An optical path between the surfaces includes a reflection from one or more totally internally reflecting (TIR) surfaces, a reflection from a TIR surface generating an evanescent wave to provide an attenuated TIR sensing function. Preferably the system further comprises a light source to optically excite said cavity at least two different wavelengths; and a detector to monitor a ring-down characteristic of the cavity at least one of the two wavelengths. Optionally the one or more TIR surfaces are provided with a functionalising material or materials such that an interaction between a said functionalising material and one or more targets to be sensed is detectable as a change in absorption of a said evanescent wave at the probe wavelength. The invention also provides a tapered fibre optic for such a system.

Further Features and Advantages of Preferred Arrangements

Further features and advantages of some implementations of the above described systems will now be described. These have previously been set out in detail in the Applicant's co-pending International patent application number PCT/GB2004/000020, filed on 8 Jan. 2004, the entire contents of which are hereby incorporated by reference.

The sensitivity of an e-CRDS or a conventional CRDS-based device may be improved by taking a succession of measurements and averaging the results. However the frequency at which such a succession of measurements can be made is limited by the maximum pulse rate of the pulsed laser employed for injecting light into the cavity. This limitation can be addressed by employing a continuous wave (CW) laser such as a laser diode, since such lasers can be switched on and off faster than a pulsed laser's maximum pulse repetition rate. However, there are significant difficulties associated with coupling light from a CW laser into the cavity, particularly where a so-called stable cavity is employed, typically comprising planar or concave mirrors.

We have previously described, in UK patent application no. 0302174.8, how these difficulties may be addressed by employing a cavity ring-down sensor with a light source, such as a continuous wave laser, of a power and bandwidth sufficient to overcome losses within the cavity and couple energy into at least two nodes of oscillation (either transverse or longitudinal) of the cavity. Preferably the light source is operable as a substantially continuous source and has a bandwidth sufficient to provide at least a half maximum power output across a range of frequencies equal to at least a free spectral range of the cavity. This facilitates coupling of light into the cavity even when modes of the light source and cavity are not exactly aligned. The light source may be shuttered or electronically controlled so that the excitation may be cut off to allow measurement of a ring-down decay curve. To facilitate accurate measurement of a ring-down time the CW light source output is preferably cut off in less than 100 ns, more preferably less than 50 ns. When driven with a CW laser the cavity preferably has a length of greater than 0.5 m more preferably greater than 10 m because a longer cavity results in closer spaced longitudinal modes.

An evanescent wave cavity-based optical sensor may comprise: an optical cavity formed by a pair of highly reflective surfaces such that light within the cavity makes a plurality of passes between the surfaces, an optical path between the surfaces including a reflection from a totally internally reflecting (TIR) surface, the reflection from the TIR surface generating an evanescent wave to provide a sensing function; a light source to inject light into the cavity; and a detector to detect a light level within the cavity. Thus absorption of said evanescent wave is detectable using the detector to provide the sensing function.

In another arrangement a cavity ring-down sensor may comprise: a ring-down optical cavity for sensing a substance modifying a ring-down characteristic of the cavity; a light source for exciting the cavity; and a detector for monitoring the ring-down characteristic. The cavity may comprise a fibre optic sensor including a fibre optic cable configured to provide access to an evanescent field of light guided within the cable for the sensing.

In general the evanescent wave may either sense a substance directly or may mediate a sensing interaction through sensing a substance or a property of a material. The detector detects a change in light level in the cavity resulting from absorption of the evanescent wave, and whilst in practice this is almost always performed by measuring a ring-down characteristic of the cavity, in principle a ring-up characteristic of a cavity could additionally or alternatively be monitored. As the skilled person will appreciate the reflecting surfaces of the cavity are optical surfaces generally characterized by a change in reflective index, and may physically comprise internal or external surfaces.

The number of passes light makes through the cavity depends upon the Q of the cavity which, for most (but not all) applications, should be as high as possible. Although the cavity ring-down is responsive to absorption in the cavity this absorption may either be direct absorption by a sensed material or nay be a consequence of some other physical effect, for example surface plasmon resonance (SPR) or measured property.

We have also previously described, in UK patent application no. 0302174.8, how in a preferred embodiment the cavity comprises a fibre optic cable with reflective ends. In embodiments this provides a number of advantages including physical and optical robustness, physically small size, durability, ease of manufacture, and flexibility, enabling use of such a sensor in a wide range of non lab-based applications.

To provide an evanescent-wave sensor a fibre optic cable may be modified to provide access to an evanescent field of light guided within the cable. The invention provides a fibre-optic sensor of this sort, for example for use in evanescent wave cavity ring-down device of the general type described above.

A fibre optic cable typically comprises a core configured to guide light down the fibre surrounded by an outer cladding of lower refractive index than the core. A sensing portion of the fibre optic cable may be configured have a reduced thickness cladding over part or all of the circumference of the fibre such that an evanescent wave from said guided light is accessible for sensing. By reducing the thickness of the cladding, in embodiments to expose the core, the evanescent wave can interact directly with a sensed material or substance or attenuation of light within the cavity via absorption of the evanescent wave can be indirectly modified, for example in an SPR-based sensor by modifying the interaction of a surface plasmon excited in overlying conductive material with the evanescent wave (a shift or modification of a plasmon resonance changing the absorption).

One, or preferably both ends of the fibre optic cable may be provided with a highly reflecting surface such as a Bragg stack. The fibre optic cable thus provides a stable cavity, that is guided light confined within the cable will retrace its path many times. Preferably the fibre optic cable (and hence cavity) has a length of at least a length of 0.5 m, and more preferably of at least 1.0 m, to facilitate coupling of a continuous wave laser to the fibre optic sensor, as described above. The sensor may be coupled to a fibre optic extension and, optionally, may include an optical fibre amplifier; such an amplifier may be incorporated within the cavity.

The fibre optic cable is preferably a step index fibre, although a graded index fibre may also be used, and may comprise a single mode or polarization-maintaining or high birefringence fibre. Preferably the sensing portion of the cable has a loss of less than 1%, more preferably less than 0.5%, most preferably less than 0.25%, so that the cavity has a relatively high Q and consequently a high sensitivity. Where the sensor is to be used in a liquid the core of the fibre should have a greater refractive index than that of the liquid in which it is to be immersed in order to restrict losses from the cavity. The sensor may be attached to a Y-coupling device to facilitate single-ended use, for example inside a human or animal body.

The skilled person will understand that features and aspects of the above described sensors and apparatus may be combined.

In all the above aspects of the invention references to optical components and to light includes components for and light of non-visible wavelengths such as infrared and other light.

These and other aspects of the present invention will now be further described, by way of example only, with reference to tile accompanying figures:

FIGS. 1a-1f show, respectively, an operating principle of a CRDS-type system, an operating principle of all e-CRDS-type system, a block diagram of a continuous wave e-CRDS system, and first, second and third total internal reflection devices for a CW e-CRDS system;

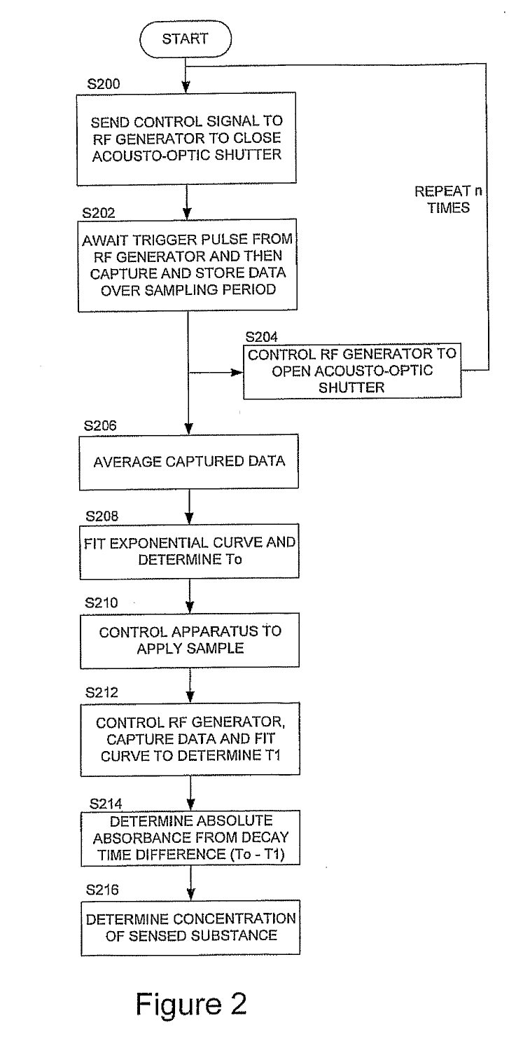

FIG. 2 shows a flow diagram illustrating operation of the system of FIG. 1c;

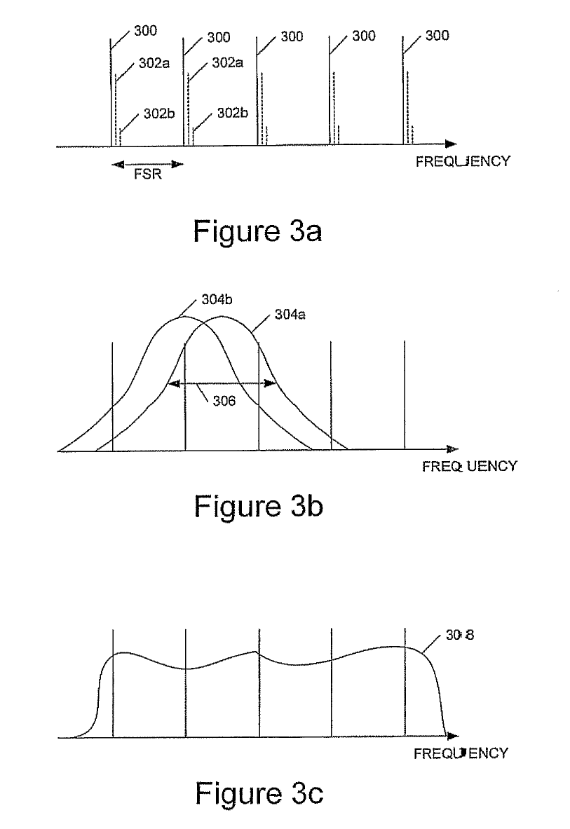

FIGS. 3a-3c show, respectively, cavity oscillation modes for the system of FIG. 1c, a first spectrum of a CW laser for use with the system of FIG. 1c, and a second CW laser spectrum for use with the system of FIG. 1c;

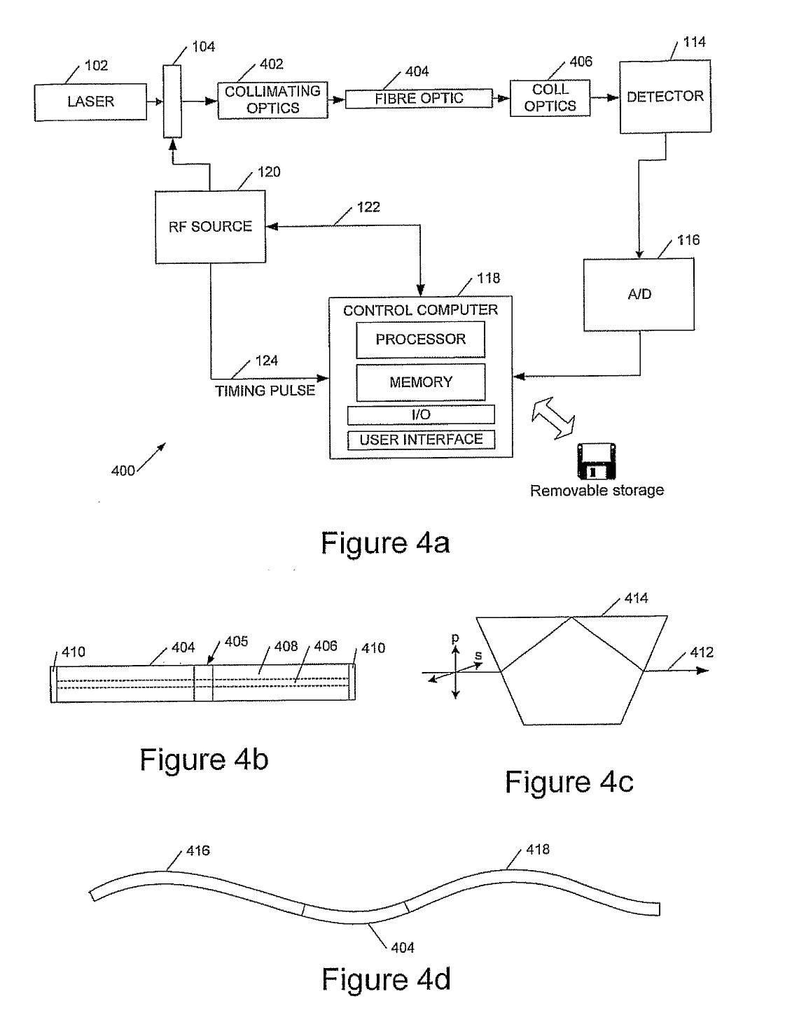

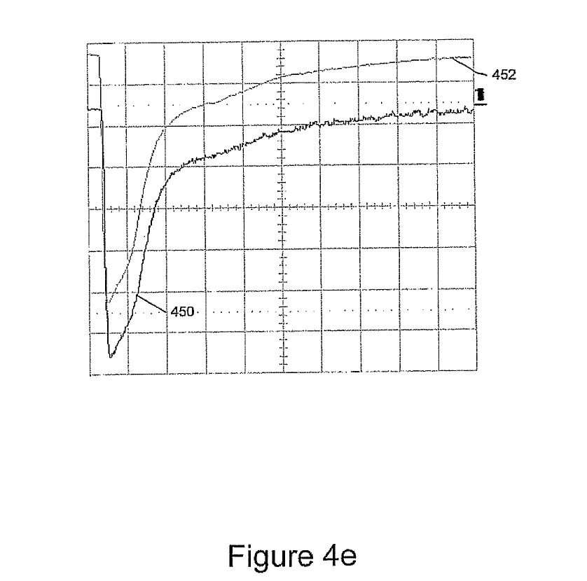

FIGS. 4a-4e show, respectively, a fibre optic-based e-CRDS system, a fibre optic cable for the system of FIG. 4a, an illustration of the effect of polarization in a total internal reflection device, a fibre optic cavity-based sensor, and fibre optic cavity ring-down profiles;

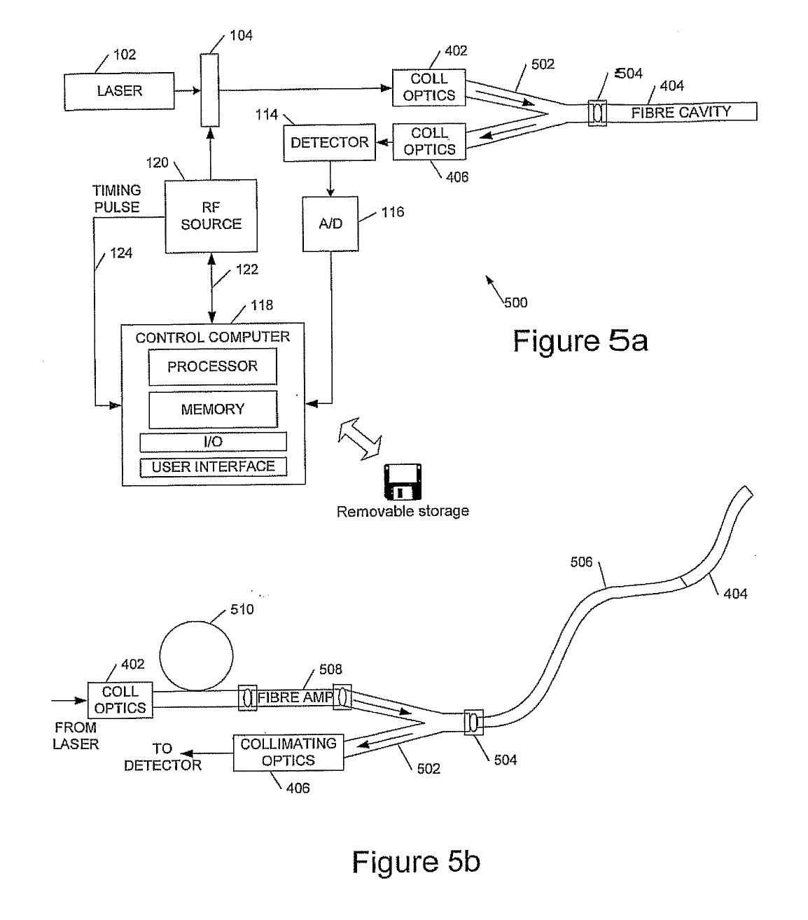

FIGS. 5a and 5b show, respectively, a second fibre optic based e-CRDS device, and a variant of this device;

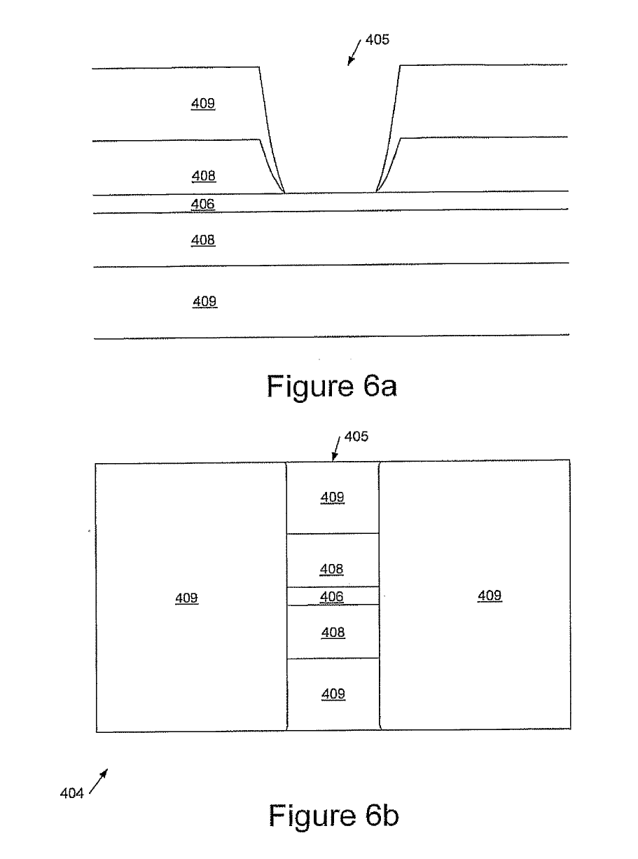

FIGS. 6a and 6b show, respectively, a cross sectional view and a view from above of a sensor portion of a fibre optic cavity;

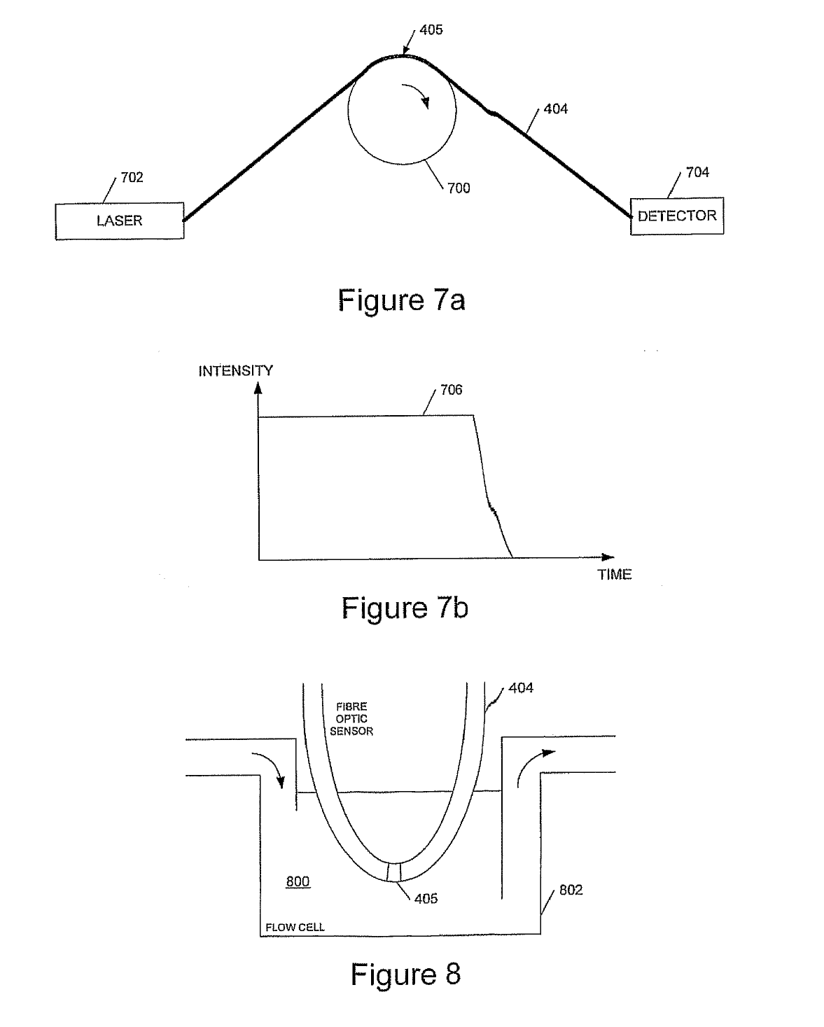

FIGS. 7a and 7b show, respectively, a procedure for forming the sensor portion of FIG. 6, and a detected light intensity-time graph associated with the procedure of FIG. 7a;

FIG. 8 shows an example of an application of an e-CRDS-based fibre optic sensor;

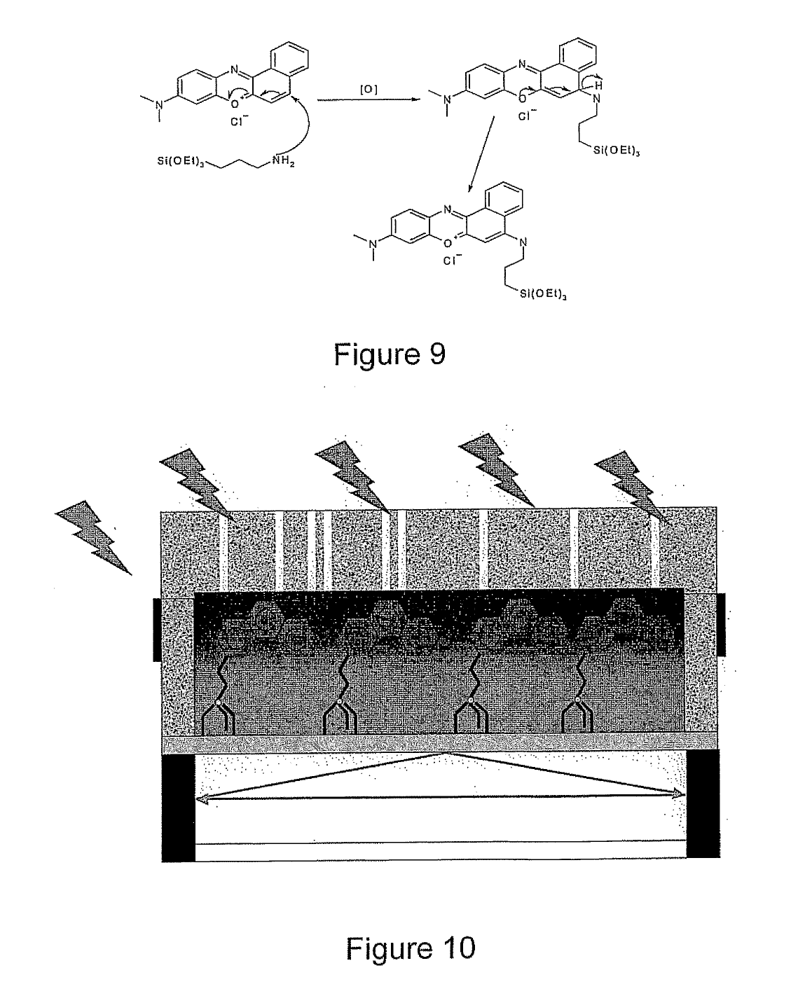

FIG. 9 shows synthesis of a Nile Blue derivative;

FIG. 10 slows a schematic diagram of a chrompohore attached to a sensor surface to provide a pH sensor;

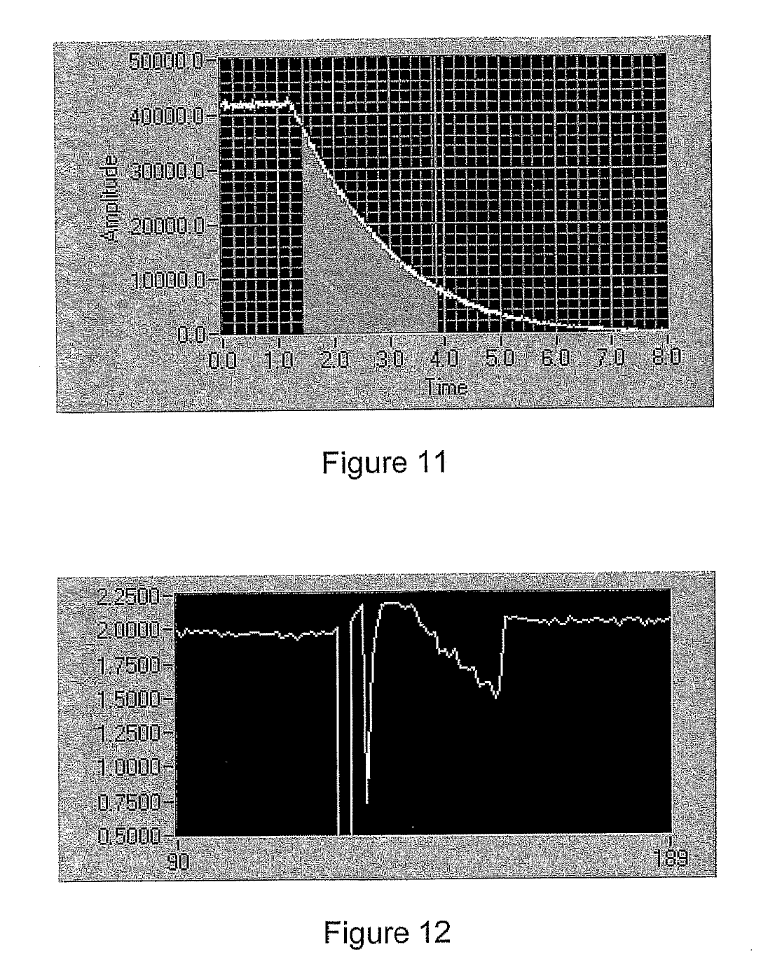

FIG. 11 shows an example of a ring-down trace for a fibre optic cavity;

FIG. 12 shows fibre optic bend losses in a 2 m fibre cavity;

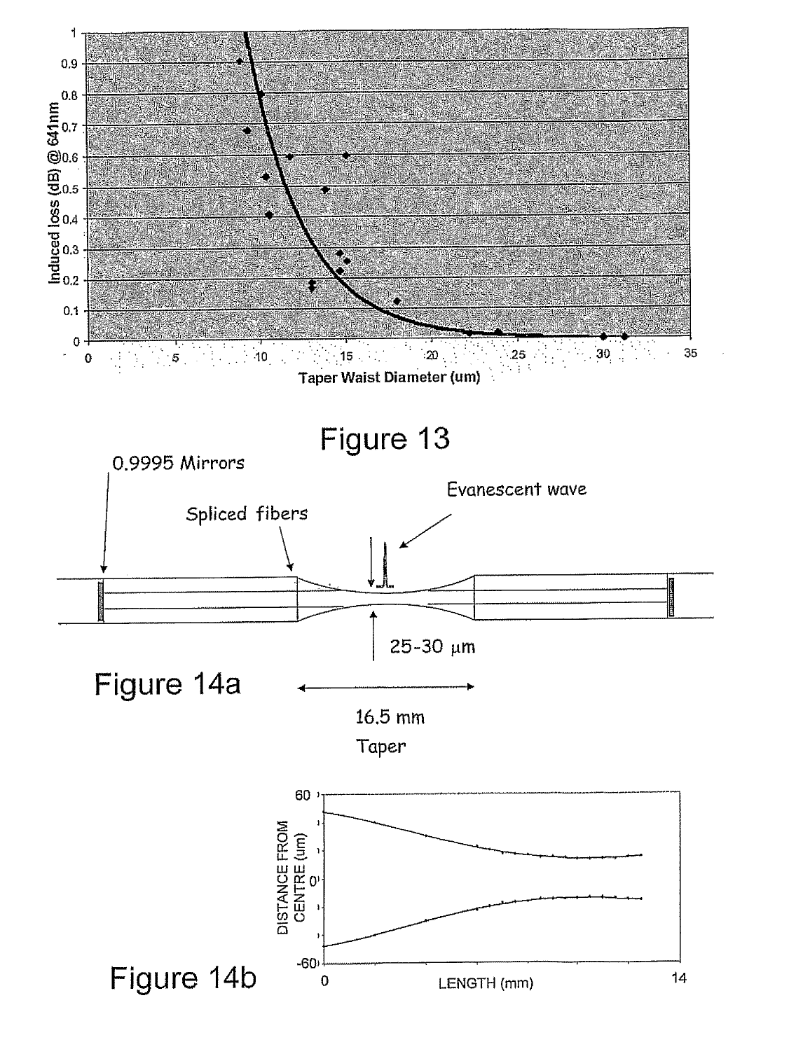

FIG. 13 shows a graph of cavity loss against taper waist for a tapered fibre optic cavity with crystal violet deposited on a totally internally reflecting evanescent wave surface of the fibre taper;

FIGS. 14a and 14b show, respectively, a fibre optic cavity incorporating a taper, and an example taper profile;

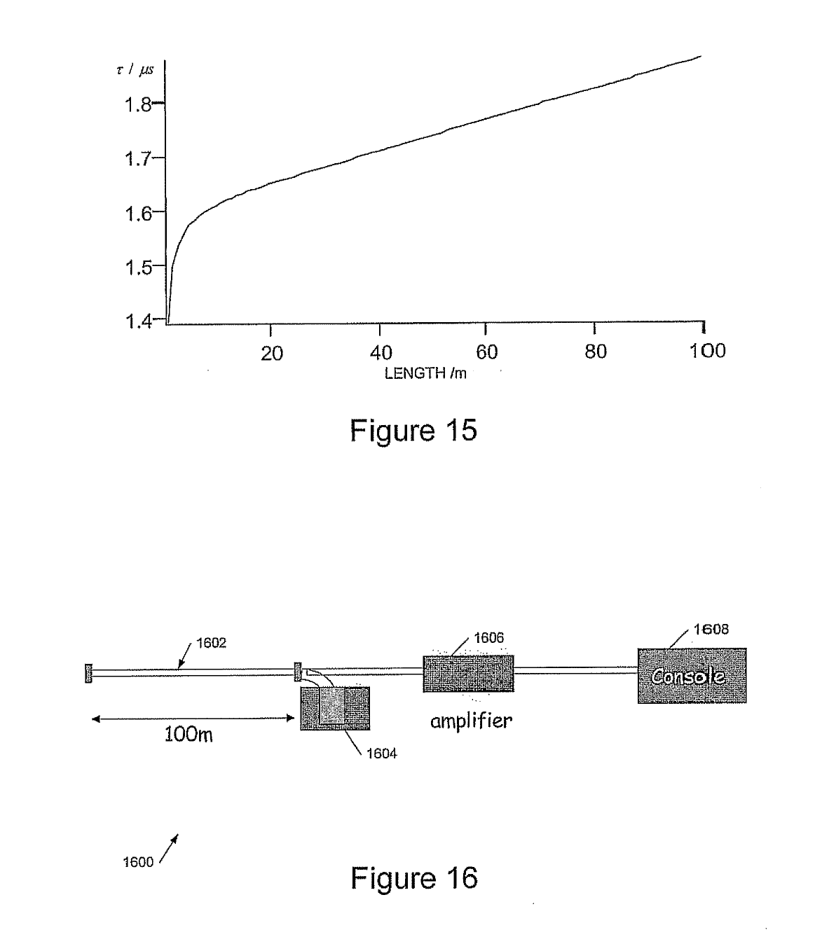

FIG. 15 shows variation of cavity ring-down time τ with cavity length for a fibre cavity;

FIG. 16 shows a wavelength division multiplexed fibre optic cavity sensor system; and

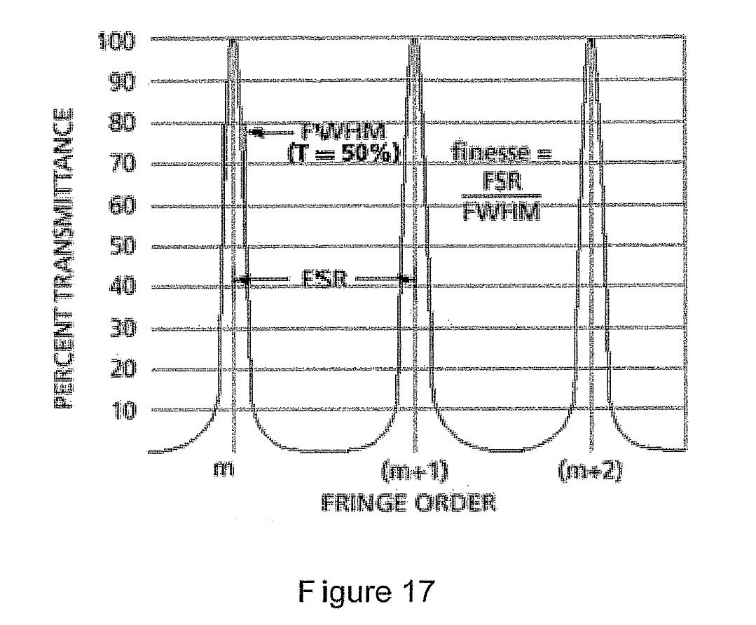

FIG. 17 shows transmittance of an optical cavity illustrating the cavity free spectral range and finesse.

We will first describe details of some particular preferred examples of e-CRDS-based sensing apparatus and will then, with particular reference to FIG. 9 onwards, describe techniques and improvements embodying aspects of the present invention.

Referring now to FIG. 1c, this shows an example of an e-CRDS-based system 100, in which light is injected into the cavity using a continuous wave (CW) laser 102. In the apparatus 100 of FIG. 1c the ring-down cavity comprises high reflectivity mirrors 108, 110 and includes a total internal reflection device 112. Mirrors 108 and 110 may be purchased from Layertec, Ernst-Abbe-Weg 1, D-99441, Mellingen, Germany. In practice the tunability of the system may be determined by the wavelength range over which the mirrors provide an adequately high reflectivity. Light is provided to the cavity by laser 102 through the rear of mirror 108 via an acousto-optic (AO) modulator 104 to control the injection of light. In one embodiment the output of laser 102 is coupled into an optical fibre and then focused onto a AO modulator 104 with 100 micron spot, the output from AOM 104 then can be collected by a further fibre optic before being introduced into the cavity resonator. This arrangement facilitates chop times of the order of 50 ns, such fast chop times being desirable because of the relatively low finesse of the cavity resonator.

Laser 102 may comprise, for example, a CW ring dye laser operating at a wavelength of approximately 630 nm or some other CW light source, such as a light emitting diode may be employed. For reasons which will be explained further below, the bandwidth of laser (or other light source) 102 should be greater than one free spectral range of the cavity formed by mirrors 108,110 and in one dye laser-based embodiment laser 102 has a bandwidth of approximately 5 GHz. A suitable dye laser is the Coherent 899-01 ring-dye laser, available from Coherent Inc, California, USA. Use of a laser with a large bandwidth excites a plurality of modes of oscillation of the ring-own cavity and thus enables the cavity be “free running”, that is the laser cavity and the ring-down cavity need not rely on positional feedback to control cavity length to lock modes of the two cavities together. The sensitivity of the apparatus scales with the square root of the chopping rate and employing a continuous wave laser with a bandwidth sufficient to overlap multiple cavity modes facilitates a rapid chop rate, potentially at greater than 100 KHz or even greater than 1 MHz.

A radio frequency source 120 drives AO modulator 104 to allow the CW optical drive to cavity 108, 110 to be abruptly switched off (in effect tile AO modulator acts as a controllable diffraction grating to steer the beam from laser 102 into or away from cavity 108, 100). A typical cavity ring-down time is of the order of a few hundred nanoseconds and therefore, in order to detect light from a significant number of bounces in the cavity, the CW laser light should be switched off in less than 100 ns, and preferably in less than about 30 ns. Data collected during this initial 100 ns period, that is data from an initial portion of the ring-down before the laser has completely stopped injecting light into the cavity, is generally discarded. To achieve such a fast switch-off time with the above mentioned dye laser an AO modulator such as the LM250 from Isle Optics, UK, may be used in conjunction with a RF generator such as the MD250 from the same company.

The RF source 120 and, indirectly, the AO modulator 104, is controlled by a control computer 118 via an IEEE bus 122. The RF source 120 also provides a timing pulse output 124 to the control computer to indicate when light from laser 102 is cut off from the cavity 108-110. It will be recognized that the timing edge of the timing pulse should have a rise or fall time comparable with or preferably faster than optical injection shut-off time.

Use of a tunable light source such as a dye laser has advantages for some applications but in other applications a less tunable CW light source, such as a solid state diode laser may be employed, again in embodiments operating at approximately 630 nm. It has been found that a diode laser may be switched off in around 10 ns by controlling the electrical supply to the laser, thus providing a simpler and cheaper alternative to a dye laser for many applications. In such an embodiment RS source 120 is replaced by a diode laser driver which drives laser 102 directly, and AO modulator 104 may be dispensed with. An example of a suitable diode laser is the PPMT LD1338-F2, from Laser 2000 Ltd, UK, which includes a suitable driver, and a chop rate for the apparatus, and in particular for this laser, may be provided by a Techstar FG202 (2 MHz) frequency generator.

A small amount of light from the ring-down cavity escapes through the rear of mirror 110 and is monitored by a detector 114, in a preferred embodiment comprises a photo-multiplier tube (PMT) in combination with a suitable driver, optionally followed by a fast amplifier. Suitable devices are tile H7732 photosensor module from Hammatsu with a standard power supply of 15V and an (optional) Ortec 9326 fast pre-amplifier. Detector 114 preferably has a rise time response of less than 100 ns more preferably less than 50 ns, most preferably less than 10 ns. Detector 114 drives a fast analogue-to-digital converter 116 which digitizes the output signal from detector 114 and provides a digital output to the control computer 118; in one embodiment an A to D on board a LeCroy waverunner LT 262 350 MHz digital oscilloscope was employed. Control computer 118 may comprise a conventional general purpose computer such as a personal computer with an IEEE bus for communication with the scope or A/D 116 may comprise a card within this computer, Computer 118 also includes input/output circuitry for bus 122 and timing line 124 as well as, in a conventional manner, a processor, memory, non-volatile storage, and a screen and keyboard user interface. The non-volatile storage may comprise a hard or floppy disk or CD-ROM, or programmed memory such as ROM, storing program code as described below. The code may comprise configuration code for LabView (Trade Mark), from National Instruments Corp, USA, or code written in a programming language such as C.

Examples of total internal reflection devices which may be employed for device 112 of FIG. 1c are shown in FIGS. 1d, 1e and I F. FIG. 1d shows a fibre optic cable-based sensing device, as described in more detail later. FIG. 1e shows a first, Pellin Broca type prism, and FIG. 1f shows a second prism geometry. Prisms of a range of geometries, including Dove prisms, may be employed in the apparatus of FIG. 1c, particularly where an anti-reflection coating has been applied to the prism. The prisms of FIGS. 1e and 1f may be formed from a range of materials including, but not limited to glass, quartz, mica, calcium fluoride, fused silica, and borosilicate glass such as BK7.

Referring now to FIG. 2, this shows a flow diagram of one example of computer program code operating on control computer 118 to control the apparatus of FIG. 1c.

At step S200 control computer 118 sends a control signal to RF source 120 over bus 122 to control radio frequency source 120 to close AO shutter 104 to cut off the excitation of cavity 108-110. Then at step S202, the computer waits for a timing pulse on line 124 to accurately define the moment of cut-off, and once the timing pulse is received digitized light level readings from detector 114 are captured and stored in memory. Data may be captured at rates up to, for example, 1 G samples per second (1 sample/ns at either 8 or 16 bit resolution) preferably over a period of at least five decay lifetimes, for example, over a period of approximately 5 μs. Computer 118 then controls RF generator to re-open the shutter and the procedure loops back to step S200 to repeat the measurement, thereby capturing a set of cavity ring-down decay curves in memory.

When a continuous wave laser source is used to excite the cavity decay curves may be captured at a relatively high repetition rate. For example, in one embodiment decay curves were captured at a rate of approximately 20 KHz per curve, and in theory it should be possible to capture curves virtually back-to-back making measurements substantially continuously (with a small allowance for cavity ring-up time). Thus, for example, when capturing data over a period of approximately 5 μs it should be possible to repeat measurements at a rate of approximately 20 KHz. The data from the captured decay curves are then averaged at step S206, although in other embodiments other averaging techniques, such as a running average, may be employed.

At step S208 the procedure fits an exponential curve to the averaged captured data and uses this to determine a decay time τ₀ for the cavity in an initial condition, for example when no material to be sensed is present. The decay time τ₀ is the time taken for the light intensity to fall to 1/e of its initial value (e=2.718). Any conventional curve fitting method may be employed; one straight-forward method is to take a natural logarithm of the light intensity data and then to employ a least squares straight line fit. Preferably data at the start and end of the decay curve is omitted when determining the decay time, to reduce inaccuracies arising from the finite switch-off time of the laser and from measurement noise. Thus for example data between 20 percent and 80 percent of an initial maximum may be employed in the curve fitting. Optionally a baseline correction to the captured light intensity may be applied prior to fitting the curve; this correction may be obtained from an initial calibration measurement.

Following this initial decay time measurement computer 118 controls the apparatus to apply a sample (gas, liquid or solid) to the total internal reflection device 112 within the ring-down cavity; alternatively the sample may be applied manually. The procedure then, at step S212, effectively repeats steps S200-S208 for the cavity including the sample, capturing and averaging data for a plurality of ring-down curves and using this averaged data to determine a sample cavity ring-down decay time τ₁. Then, at step S214, the procedure determines an absolute absorption value for the sample using the difference in decay times (τ₀−τ₁) and, at step S216, the concentration of the sensed substance or species can be determined. This is described further below.

In an evanescent wave ring-down system such as that shown in FIG. 1c the total (absolute) absorbance can be determined from Δτ=τ₁−τ₀ using equation 2 below.

$$Abs = \frac{Δ t}{τ {τ}_{0}^{-}} ( \frac{{t}_{r}}{2} ) \qquad ( Equation 2 )$$

In equation tᵣ is the round trip time for the cavity, which can be determined from the speed of light and from the optical path length including the total internal reflection device. The molecular concentration can then be determined using equation 3;
Absorbance=εCL (Equation 3)
where ε is the (molecular) extinction co-efficient for the sensed species, C is the concentration of the species in molecules per unit volume and L is the relevant path length, that is the penetration depth of the evanescent wave into the sensed medium, generally of the order of a wavelength. Since the evanescent wave decays away from the total internal reflection interface strictly speaking equation 3 should employ the Laplace transform of the concentration profile with distance from the TIR surface, although in practice physical interface effects may also come into play. A known molecular extinction co-efficient may be employed or, alternatively, a value for an extinction co-efficient for equation 3 may be determined by characterizing a material beforehand.

Referring next to FIG. 3a this shows a graph of frequencies (or equivalently, wavenumber) on the horizontal axis against transmission into a high Q cavity such as cavity 108, 110 of FIG. 1c, on the vertical axis. It can be seen that, broadly speaking, light can only be coupled into the cavity at discrete, equally-spaced frequencies corresponding to allowed longitudinal standing waves within the cavity known as longitudinal cavity modes. The interval between these modes is known as the free spectral range (FSR) of the cavity and is defined as equation 4 below.
FSR=(l/2c′) (Equation 4)

Where l is the length of the cavity and c′ is the effective speed of light within the cavity, that is the speed of light taking into account the effects of a non-unity refractive index for materials within the cavity. For a one-meter cavity, for example, the free spectral range is approximately 150 MHz. Lines 300 in FIG. 3a illustrate successive longitudinal cavity modes. FIG. 3a also shows (not to scale) a set of additional, transverse cavity modes 302a, b associated with each longitudinal mode, although these decay rapidly away from the longitudinal modes. The transverse modes are much more closely spaced than the longitudinal modes since they are determined by the much shorter transverse cavity dimensions. To couple continuous wave radiation into the cavity described by FIG. 3a the light source with sufficient bandwidth to overlap at least too longitudinal cavity modes may be employed. This is shown in FIG. 3b.

FIG. 3b shows FIG. 3a with an intensity (Watts per m²) or equivalently power spectrum 304a, b for a continuous wave laser superimposed. It can be seen that provided the full width at half maximum 306 of tie laser output spans at least one FSR laser radiation should continuously fill the cavity, even if the peak of the laser output moves, as shown by spectra 304a and b. In practice the laser output may not have the regular shape illustrated in FIG. 3b and FIG. 3c illustrates, diagrammatically an example of the spectral output 308 of a dye laser which, broadly speaking, comprises a super imposition of a plurality of broad resonances at the cavity modes of the laser.

Referring again to FIG. 3b it can be seen that as the peak of the laser output moves, although two modes are always excited these are not necessarily the same two modes. It is desirable to continuously excite a cavity mode, taking into account shifts in mode position caused by vibration and/or temperature changes and it is therefore preferable that the laser output overlaps more than two modes, for example, five modes (as shown in FIG. 3c) or ten modes. In this way even if mode or laser frequency changes one mode at least is likely to be continuously excited. To cope with large temperature variations a large bandwidth may be needed and for certain designs of instruments, for example, fibre optic-based instruments it is similarly desirable to use a CW laser win a bandwidth of five, ten or more FSRs. For example a CW ring dye laser with a bandwidth of 5 GHz has advantageously employed with a cavity length of approximately one meter and hence an FSR of approximately 1501MHz.

For clarity transverse modes have not been shown in FIG. 3b or FIG. 3c but it will be appreciated light may be coupled into modes with a transverse component as well as a purely longitudinal modes, although to ensure continuous excitation of a cavity it is desirable to overlap at least two different longitudinal modes of the cavity

In order to excite a cavity mode sufficient power must be coupled into the cavity to overcome losses in the cavity so that the mode, in effect rings up. Preferably, however, at least half the maximum laser intensity at its peak frequency is delivered into at least two modes since this facilitates fast repetition of decay curve measurement and also increases sensitivity since decay curves will begin from a higher initial detected intensity. It will be appreciated that when the bandwidth of the CW laser overlaps with longitudinal modes of the ring-down cavity as described above, the power within the cavity depends on the incident power of the exciting lasers which enables the power within the cavity to be controlled, thus facilitating power dependent measurements and sensing.

FIG. 4a shows a fibre optic-based e-CRDS type sensing system 400 similar to that shown in FIG. 1c, in which like elements are indicated by like reference numerals. In FIG. 4a, however, mirrors 108, 110, and total internal reflection device 112 are replaced by fibre optic cable 404, the ends of which have been treated to render them reflective to form a fibre optic cavity. In addition collimating optics 402 are employed to couple light into fibre optic cable 404 and collimating optics 406 are employed to couple light from fibre optic cable 404 into detector 414.

FIG. 4b shows further details of fibre optic cable 404, which, in a conventional manner comprises a central core 406 surrounded by cladding 408 of lower refractive index than the core. Each end of the fibre optic cable 404 is, in the illustrated embodiment polished fat and provided with a multi layer Bragg stack 410 to render it highly reflective at the wavelength of interest. As the skilled person will 1e aware, a Bragg stack is a stack of quarter-wavelength thick layers of materials of alternating refractive indices. To deposit the Bragg stacks the ends of the fibre optic cable are first prepared by etching away the surface and then polishing the etched surface flat to within, for example, a tenth of a wavelength (this polishing criteria is a commonly adopted standard for high-precision optical surfaces), Bragg stacks may then be deposited by ion sputtering of metal oxides; such a service is offered by a range of companies including the above-mentioned Layertec, Gmbh. Fibre optic cable 404 includes a sensor portion 405, as described further below.

Preferably optical fibre 404 is a single mode step index fibre, advantageously a single mode polarization preserving fibre to facilitate polarization-dependent measurements and to facilitate enhancement of the evanescent wave field. Such enhancement can be understood with reference to FIG. 4c which shows total internal reflection of light 412 at a surface 414. It can be seen from inspection of FIG. 4c that p-polarized light (within the plane containing light 412 and the normal to surface 414) generates an evanescent wave which penetrates further from surface 414 than does s-polarized light (perpendicular to the plane containing light 412 and the normal to surface 414).

The fibre optic cable is preferably selected for operation at a wavelength or wavelengths of laser 102. Thus for example, where laser 102 operates in the region of 630 nm so called short-wavelength fibre may be employed, such as fibre from INO at 2470 Einstein Street, Sainte-Foy, Quebec, Canada. Broadly speaking suitable fibre optic cables are available over a wide range of wavelengths from less than 500 nm to greater than 1500 nm. Preferably low loss fibre is employed. In one embodiment single mode fibre (F601A from INO) with a core diameter of 5.6 μm (a cut-off at 540 nm, numerical aperture of 0.11, and outside diameter of 125 μm)and a loss of 7 dB/km was employed at 633 nm, giving a decay time of approximately 1.5 μs with a one meter cavity and an end reflectivity of R=0.999. In general the decay time is given by equation 5 below where the symbols have their previous meanings, f is the loss in the fibre (units of m⁻¹ i.e. percentage loss per metre) and l is the length of the fibre in metres.
Δτ=tᵣ/{2(1−R)+fl} (Equation 5)

FIG. 4d illustrates a simple example of an alternative configuration of the apparatus of FIG. 4a, in which fibre optic cavity 404 is incorporated between two additional lengths of fibre optic cable 416, 418, light being injected at one end of fibre optic cable 416 and recovered from fibre optic cable 418, which provides an input to detector 114. Fibre optic cables 414, 416 and 418 may be joined in any conventional manner, for example using a standard FC/PC-type connector.

FIG. 4e shows two examples of cavity ring-down decay curves obtained with apparatus similar to that shown in FIG. 4a with a cavity of length approximately one meter and the above mentioned single mode fibre. FIG. 4e shows two sampling oscilloscope traces captured at 500 mega samples per second with a horizontal (time) grid division of 0.2 μs and a vertical-rid division of 50 μV. Curve 450 represents a single measurement and curve 452 and average of nine decay curve measurements (in FIG. 4e the curve has been displaced vertically for clarity) the decay time for the averaged decay curve 452 was determined to be approximately 1.7 μs. The slight departure from an exponential shape (a slight kink in the curve) during the initial approximately 100 ns is a consequence of coupling of radiation into the cladding of the fibre, which is rapidly attenuated by the fibre properties and losses to the surroundings.

Referring now to FIG. 5a this shows a variant of the apparatus of FIG. 4a, again in which like elements are indicated by like reference numerals. In FIG. 5a a single-ended connection is made to fibre cavity 404 although, as before, both ends of fibre 404 are provided with highly reflecting surfaces. Thus in FIG. 5a a conventional Y-type fibre optic coupler 502 is attached to one end of fibre cavity 404, in the illustrated example by an FC/PC screw connector 504. The Y connector 502 has one arm connected to collimating optics 402 and its second arm connecting to collimating optics 406. To allow lamer light to be launched into fibre cavity 404 and light escaping from fibre cavity 404 to be detected from a single end of the cavity. This facilitates use of a fibre cavity-based sensor (such as is described in more detail below) in many applications, in particular applications where access both ends of the fibre is difficult or undesirable. Such applications include intra-venous sensing within a human or animal body and sensing within an oil well bore hole.

FIG. 5b shows a variant in which fibre cavity 404 is coupled to Y-connector 502 via an intermediate length of fibre optic cable 506 (,which again may be coupled to cable 504 via a FC/PC connector). FIG. 5b also illustrates the use of an optional optical fibre amplifier 508 such as an erbium-doped fibre amplifier. In the illustrated example fibre amplifier 508 is acting as a relay amplifier to boost tile output of collimating optics 402 after a long run through a fibre optic cable loop 510. (For clarity in FIG. 5b the pump laser for fibre amplifier 508 is not shown). The skilled person will appreciate that many other configurations are possible. For example provided that the fibre amplifier is relatively linear it may be inserted between Y coupler 502 and collimating optics 506 without great distortion of the decay curve. Generally speaking, however, it is preferable that detector 114 is relatively physically close to the output arm of Y coupler 512, that is preferably no more than a few centimeters from the output of this coupler to reduce losses where practically possible; alternatively a fibre amplifier may be incorporated within cavity 404. In further variants of the arrangement of figures multiple fibre optic sensors may be employed, for example by splitting the shuttered output of laser 102 and capturing data from a plurality of detectors, one for each sensor. Alternatively laser 102, shutter 104, and detector 114 may be multiplexed between a plurality of sensors in a rotation.

To utilize the fibre optic cavity 404 as a sensor of an e-CRDS based instrument access to an evanescent wave guided within the fibre is needed. FIGS. 6a and 6b show one way in which such access may be provided. Broadly speaking a portion of cladding is removed from a short length of the fibre to expose the core or more particularly to allow access to the evanescent wave of light guided in the core by, for example, a substance to be sensed.

FIG. 6a shows a longitudinal cross section through a sensor portion 405 of the fibre optic cable 404 and FIG. 6b shows a view from above of a part of the length of fibre optic cable 404 again showing sensor portion 405. As previously explained the fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen from FIG. 6 at the sensor portion of the cable tile cladding 408 is at least partially removed to expose the core and hence to permit access to the evanescent wave from guided light within the core. The thickness of the cladding is typically 100 nm or more, but the cladding need not be entirely removed although preferably less than 10 μm thickness cladding is left at the sensor portion of the cable. It will be appreciated that there is no specific restriction on the length of the sensor portion although it should be short enough to ensure that losses are kept well under one percent. It will be recognized that, if desired, multiple sensor portions may be provided on a single cable.

For a Dove prism the characteristic penetration depth, dₚ, of an evanescent wave, at which the wave amplitude falls to 1/e of its value at the interface is determined by:

$${d}_{p} = \frac{λ}{2 π {( {( sin ( ϑ ) )}^{2} - {n}_{12}^{2} )}^{\frac{1}{2}}}$$

where λ is the wavelength of the, θ is the angle of incidence at the interface with respect to the normal and n₂ is the ratio of the refractive index of the material (at λ) to the medium above the interface. A similar expression applies for a fibre optic. Generally dₚ is less than 500 nm; for a typical configuration dₚ is less than 200 nm, often less than 100 nm.

A sensor potion 405 on a fibre optic cable may be created either by mechanical removal of the casing 409 and portion of the cladding 408 or by chemical etching. FIGS. 7a and 7b demonstrate a mechanical removal process in which the fibre optic cable is passed over a rotating grinding wheel (with a relatively fine grain) which, over a period of some minutes, mechanically removes the casing 409 and cladding 408. The point at which the core 406 is optically exposed may be monitored using a laser 702 injecting light into the cable which is guided to a detector 704 where the received intensity is monitored. Refractive index matching fluid (not shown in FIG. 7a) is provided at the contact point between grinding wheel 700 and table 404, this fluid having a higher refractive index than the core 406 so that when the core is exposed light is coupled out of the core and the detected intensity falls to zero.

FIG. 7b shows a graph of light intensity received by detector 704 against time, showing a rapid fall in received intensity at point 706 as the core begins to be optically exposed so that energy from the evanescent wave can couple into the index matching fluid and hence out of the table. With a chemical etching process a similar procedure may be employed to check when the evanescent wave is accessible, that is when the core is being exposed, by removing the fibre from the chemical etch ant at intervals and checking light propagation through the fibre when index matching fluid is applied at the sensor portion of the fibre. An example of a suitable enchant is hydrofluoric acid (HF).

FIG. 8 shows a simple example of an application of the apparatus of FIG. 4a. Fibre optic cable 404 and sensor 405 are immersed in a flow cell 802 through which is passed an aqueous solution containing a chromophore whose absorbance is responsive to a property to be measured such as pH. Using the apparatus of FIG. 4a at a wavelength corresponding to an absorption band of the chromophore very small changes, in this example pH, may be measured.

The above described instruments may be used for gas, liquid and solid phase measurements although they are particularly suitable for liquid and solid phase materials. Instruments of the type described, particularly those of tie type shown in FIG. 1c may operate at any of a wide range of wavelengths or at multiple wavelengths. For example optical high reflectivity are mirrors available over the range 200 nm-20 μm and suitable light sources include Ti:sapphire lasers for the region 600 nm-1000 nm and, at the extremes of the frequency range, synchrotron sources. Instruments of the type shown in FIG. 4a may also operate at any of a wide range of wavelengths provided that suitable fibre optic cable is available.

We will now describe some aspects of fibre cavity design and sensors based upon instruments/apparatus employing a fibre optic cavity.

Implementation of evanescent wave cavity ring-down spectroscopy (e-CRDS) in a rugged field instrument is facilitated by construction of the optical resonator within a fibre optic. This effectively makes alignment automatic and makes the cavity robust but highly flexible. The choice of fibre optic and wavelength of operation is controlled by the optical loss budget with the cavity to enable the e-CRDS ring-down technique to be implemented and, for functionalised surfaces, the design of the absorption specific chemistry for the preparation of these surfaces. The loss budget for the optical resonator determines the ultimate sensitivity of the technique together with the ability to determine the losses from each component in the fabrication of the cavity.

As a preliminary we outline techniques for the preparation of functionalised surfaces; these are described in more detail in the Applicant's co-pending UK patent application entitled Functionalised Surface Sensing Apparatus and Methods, filed on the same day as this patent application, the contents of which are hereby incorporated by reference in their entirety.

Broadly speaking, and as described above, reflection from a totally internally reflecting (TIR) surface generates an evanescent wave to provide a sensing function, and the TIR surface is provided with a functionalising material over at least part of its surface such that tile evanescent wave is modified by the functionalising material so that an interaction between the functionalising material and a target to be sensed is detectable as a change in absorption of the evanescent wave and hence a change in the ring-down characteristics (time) of the cavity. The functionalising material may, for example, be a host for a guest species or ligand, and in preferred arrangements comprises a chromophore (to provide absorption at a wavelength of operation of the apparatus). The functionalising material may be attached by means of a molecular tether or link, where the TIR surface comprises silica the tether may be attached by a Si—O—Si bond.

Further understanding of the way in which a sensor surface may be functionalised may be gained by considering the example of a pH sensor based upon the Nile Blue chromophore (absorbing at 637 nm). A tether can be attached to this, as shown in FIG. 9, by refluxing with 3-aminopropyltriethoxysilane in methanol solution to form a silyl functionalised Nile Blue derivative as illustrated. FIG. 10 shows a schematic diagram of the chrompohore attached to a sensor surface to provide a pH sensor. The tether has a triethoxysilane group that forms a Si—O—Si bond at the surface to bind the species to the surface. The ethoxy group acts as a leaving group when the silicon undergoes nucleophilic attack by the surface silanol group. The OEt leaving group can be replaced with a chloro group producing a chlorosilane derivative with different tethering properties. The tethering process can be varied to provide 1, 2 or 3-OEt or —Cl on the tethered molecule to establish 1, 2 or 3 anchoring points to the surface or the formation of a cross-linked surface polymer chain. The skilled person will appreciate that using these general techniques many different functionalisations may be applied to an evanescent wave surface of a cavity ring-down sensor, either one functionalisation per surface (in a multi-surface sensing apparatus, as described further below) separately or in combination at a single sensing surface.

We now describe fabrication details of some fibre optic cavities.

Fibre optic was purchased from Oz Optics (Ontario, Canada) with a minimum absorption at 633 nm specified at 7 dB km⁻¹. The losses at 633 inn are dominated by the absorption losses of the silica in the fibre and a shift to longer wavelength can allow the operation of the cavity in a region of lower losses in the absorption spectrum of the silica. The minimum absorption occurs at 1.5 μm, the telecom wavelength. The specification for the fibre is shown in Table 1 below.

TABLE 1
Fibre specification INO 601A

| | |
|---|---|
| Losses/dB km⁻¹ | 7 |
| Numerical Aperture | 0.11 |
| Core Diameter/μm | 5.6 |
| Cladding Diameter/μm | 125 |
| Optimised Wavelength/nm | 635 |
| Cut off Wavelength/nm | 540 |

The fibres were fabricated in two batches, one supplied and prepared with high-reflectivity mirror coatings by INO (Institute National d'Optique—National Optics Institute, Quebec, Canada), and one supplied by Oz optics with high-reflectivity mirror coatings provided by Research Electro Optics (REO), Inc, of Colorado, USA. Each fibre was polished flat as part of a standard INO preparation procedure and then connectorised with a standard FC/PC patchchord connector. For the REO batch the mirror coatings were applied to the end of the polished fibre with the FC/PC connectors in place. Mie fabrication process may coat the mirrors before or after connectorisation. The batch from INO was supplied as patch-chords with a rugged plastic covering around the fibres (likely added after the mirrors were coated); the batch sent to REO had no outer coating, except the silicone covering, around 1 mm in diameter to minimise out-gassing during the coating processes.

Two mirror reflectivity custom coating runs were performed, by Oz Optics and by REO. Oz specified a coating reflectivity of better than 0.9995; REO specified 0.9999 or better reflectivities by their standard processes. These mirror coatings reflectivities are manufacturer's estimates.

Fibre optic tapers were prepared under contract by Sifam Fibre Optics, Torquay, Devon, UK, tapering the fibre optic revealing some of the evanescent wave, as described above, allowing it to couple to molecules in the outside medium. This was measured with a solution of crystal violet (CV⁺), which has an absorbance at 633 nm-CV⁺placed on the surface of the taper absorbs the radiation from the evanescent field and this is seen as a loss in the intensity of the radiation in the fibre, as shown in the graph of induced loss against taper waist (corresponding to extension) shown in FIG. 13.

The fibre of Table 1 has a “W” index profile which leads to increased losses in the tapering process, and therefore tapers were drawn in the fibre specified in Table 2 below, which has a simple step index profile. A tapered fibre was then spliced into a cavity to provide an overall cavity length of 4.2 m; more than one taper could be spliced into a cavity in a similar way. The cavity length was chosen to be this length to increase the ring down time τ (which has a linear dependence on tᵣ the round trip time). To reduce the splicing losses the mirrors may be deposited onto a fibre with a desired index profile.

TABLE 2

| Fibre Lot ID | CD01875XA2 |
|---|---|
| Cladding Diameter/μm | 124.72/125.51 |
| Coating Diameter/μm | 248.77/248.9 |
| Attenuation at 630 nm/dB km⁻¹ | 7.09 |
| Cutoff/nm | 612.4/619.5 |
| Mean Fibre Diameter at 630 nm/μm | 4.28/4.62 |

Observed ring down times, τ, for a selection of un-tapered fibre cavities (fabricated and coated by Oz Optics) are given in Table 3 below; FIG. 11 shows a ring-down trace for cavity FC2. This was captured using a digital oscilloscope and averaged 256 times at a repetition rate of 8 KHz and then input to a signal processor (personal computer) which fitted a single exponential using a standard (non-linear) Levenberg-Marquardt procedure.

TABLE 3

| Cavity | Cavity Length/m | τ ± σ/μs | Comments |
|---|---|---|---|
| FC1 | 2 | 1.23 ± 0.023 | Oz Optics Fibre and |
| | | | Mirrors στ/τ = 0.96% |
| FC2 | 2 | 2.176 ± 0.033 | Oz Optics Fibre and |
| | | | Mirrors στ/τ = 1.29% |
| FC3 | 1 | 0.823 ± 0.013 | Oz Optics Fibre and |
| | | | Mirrors στ/τ = 1.58% |
| FC4 | 1 | 1.050 ± 0.015 | Oz Optics Fibre and |
| | | | Mirrors στ/τ = 1.43% |
| FC5 | 1 | 0.538 ± 0.065 | Oz Optics Fibre and |
| | | | Mirrors στ/τ = 1.20% |
| FC6 | 1 | 0.402 ± 0.025 | Oz Optics Fibre and |
| | | | Mirrors στ/τ = 0.61% |
| FC7 | 2 | 1.870 ± 0.023 | Oz Optics Fibre and |
| | | | Mirrors στ/τ = 1.22% |
| FC8 | 2 | 0.801 ± 0.028 | Oz Optics Fibre and |
| | | | Mirrors στ/τ = 3.54% |

The CRDS technique facilitates measurements of fibre optic propagation and fabrication losses. Measurements of the effect of bending on a fibre cavity are summarised in Table 4 and shown in FIG. 12. Conventionally the bend radius of a fibre is the minimum radius at which the fibre should be bent to avoid significant propagation losses; a typical radius is ˜2 cm.

An evolving τ trace is shown in FIG. 12, with ring-down time τ on the y-axis and time on the x-axis. After 40 time points the fibre was bent in half, which resulted in a measured τ of less than 50 ns. Bending the fibre with a 2 mm bend radius resulted in a τ of ˜0.73 μs (a loss of 0.058 dB). Subsequent bends were formed by wrapping the coated fibre around a 8 mm diameter former, making up to 5 turns, and FIG. 12 shows the resulting stepwise increase in losses associated with each successive turn.

TABLE 4

| Bend Radius/mm | τ/μs | Δτ (τ₀ = 2.176) | Observed Loss/dB |
|---|---|---|---|
| 0 | 2.176 | 0 | 0.019 |
| 2 | 0.731 | 1.445 | 0.058 |
| 4 × 1 turn | 2.033 | 0.143 | 0.0018 |
| 4 × 2 turns | 1.980 | 0.196 | 0.0023 |
| 4 × 3 turns | 1.884 | 0.292 | 0.0034 |
| 4 × 4 turns | 1.552 | 0.624 | 0.0082 |
| 4 × 5 turns | 1.471 | 0.705 | 0.0097 |

We turn next to the fabrication of tapered cavities. The telecoms industry has developed a technology for fusing fibre optics together, coupling two or more input fibres into one output fibre. This achieved by tapering the fibres and fusing the cores of the incoming fibres to the output fibre. In tapering a single fibre optic some of the evanescent field is revealed from tile core and samples the region outside the taper—this is the basis of the tapered fibre cavity.

Tapered fibre cavities may be made by pulling under heating to a known radius to produce the taper, for example by Sifam, as mentioned above. The taper may then be spliced into a fibre cavity to form a complete sensor, as shown in FIG. 14a. The observed losses for a taper prepared with INO fibre are large due to the “W” shaped refractive index profile of these fibres and instead a step index profile fibre is preferable; this may then be spliced into an INO fibre cavity. The tapered region may be supported in a ‘U’ shaped gutter. In an alternative fabrication technique mirrors are deposited onto a fibre that is appropriate for tapering; losses of the taper may then be monitored by CRDS during the taper preparation. FIG. 14b shows an example taper profile with a minimum diameter of 27 μm and a length of 27 mm (here taking the taper length as the distance between points at which the fibre has twice its minimum diameter).

FIG. 13 shows results of experiments performed to investigate the evanescent leave coupling to crystal violet as a function of taper diameter. The experiments were performed in the presence of crystal violet (CV) 122 μM at pH 8.6, chosen to maximise the binding of CV to the (charged) silica surface. The results show that losses are tolerable for tapers of diameter 25-30 μm.

The measured ring-down times and losses for each of four tapered fibre optic cavities are shown in Table 5—EV1 and EV2 are cavities prepared from INO fibre with REO mirrors specified at R=0.9999; EV3 and EV5 comprise INO fibre and mirrors specified at R=0.9995-EV3 and EV5 have signal intensities from a photomultiplier (PMT, 50Ω termination) of the order 40 mV whereas EV1 and EV2 have a signal intensity of order 7 mV.

TABLE 5

| Fibre | Taper | Estimated | | Observed |
|---|---|---|---|---|
| Cavity | Length/mm | Loss/dB | Observed τ/ns | Loss/dB |
| EV1 | 16.15 | — | 114 ± 1.7 | 0.86 |
| EV2 | 16.42 | 0.01 | 129 ± 7 | 0.75 |
| EV3 | 16.70 | 0.02 | 300 ± 3 | 0.31 |
| EV5 | 16.78 | 0.01 | 337 ± 15 | 0.27 |

We next consider fibre cavity losses.

The losses in fibre optic are measured in decibels (dB) per kilometre, with the dB defined by the following equation:

$$dB = 10 {log}_{10} ( \frac{{P}_{in}}{{P}_{out}} ) \qquad ( 6 )$$

where Pᵢₙ and Pₒᵤₜ are the input and output powers respectively. The losses in CRDS experiments are measured by the ring-down time, τ, with contributions from:
Iₙ=(R(ν)T_{f} Lᵢexp(−α(ν)l))²ⁿI₀ (7)

Where R(ν) is the frequency dependent reflectivity of the mirrors, T_{f} is the transmission loss of the fibre and Lᵢ are all other losses to include scatter and diffraction effects. The absorption of any molecular species within the cavity is assumed to follow Beers Law with l being the length of the cavity and n is the number of bounces. Absorption within the evanescent field will also be by Beers law but with an effective penetration depth for the radiation, d₁and a concentration profile. Equation 7 can be re-arranged to give:
Iₙ=exp(−2n(α(ν)l−lnR−lnT_{f}−lnLᵢ₎₎I₀ (8)

Transforming to the time variable t=2nl/c, where c is the speed of light and/is the length of the cavity, the expression now shows the expected form for the exponential decay of radiation intensity within the cavity:

$$I ( t ) = exp ( - \frac{ct}{l} ( α ( v ) l - ln R - ln {T}_{f} - ln {L}_{i} ) ) {I}_{0} \qquad ( 9 )$$

The ring down time of the cavity, τ, is given by:

$$τ = \frac{{t}_{r}}{2 ( α l - ln ( R ) - ln ( {T}_{f} ) - ln ( {L}_{i} ) )} \qquad ( 10 )$$

Where tᵣ is the round trip time of the cavity. Using the Taylor series approximation −1n(R)≈(1−R) at R=1, the conventional equation for the losses of an empty free-space cavity with losses dominated by the mirror reflectivities can be recovered:

$$τ = \frac{{t}_{r}}{2 ( 1 - R )} \qquad ( 11 )$$

where tᵣ is the round-trip time and R is the mirror reflectivity.

The Taylor series expansion is a good approximation for R=0.9999 with −1n(R)−(1−R)=5×10⁻⁹, five parts in a billion. With R=0.999, the difference is 5×10⁻⁷, or five parts in 10 million and for R=0.99, the difference is 5×10⁻⁵, five parts in 100 000. So for ail calculations with fibre cavities this is a good approximation.

Considering now non-tapered fibre cavity losses, the losses in the fibre cavities without the tapers have an exponential decay with a ring down time given by:

$$τ = \frac{{t}_{r}}{2 ( ( 1 - R ) + ( 1 - {T}_{f} ) + ( 1 - {L}_{i} ) )} \qquad ( 12 )$$

With a cavity of 2m in length and a specified fibre loss of 7 dB km⁻¹, R=0.9995 and Lᵢ=0, the predicted ring down time of the cavity is (all calculations of losses are per round-trip with a silica refractive index of 1.4601):

$$\begin{matrix}τ = \frac{\frac{2 \times 2}{c} \times 1.4601}{2 ( ( 5 \times {10}^{- 4} ) + ( 1 - {10}^{\frac{7 \times 4 m}{{10}^{4}}} ) )} \\ τ = \frac{1.9533 \times {10}^{- 8}}{2 ( ( 5 \times {10}^{- 4} ) + 6.426 \times {10}^{- 3} )} \\ τ = 1.410 μ s\end{matrix} \qquad ( 13 )$$

This compares with the measured cavity τ=1.23±0.025 μs (for FC1). Hence the fibre transmission losses dominate the losses in the cavity and determine the ring down time. There are still some additional losses that are not accounted for by the 7 dB km⁻¹ loss for the fibre and the effective fibre losses are 8.6 dB km⁻¹ (cf FC2 where τ=2.176 is consistent with effective fibre losses of 4 dB/km). This may be because fabrication of the high reflectivity mirrors on the end of the fibre may not be as easy as expected and the observed mirror reflectivities may be lower than the specified 0.9995. Dropping the mirror reflectivities to 0.999 gives a limiting value of τ=1.315 μs. The discrepancy in the mirror reflectivity and the estimate of the fibre loss are all very close to the observed limiting loss and can easily be explained in terms of fabrication losses (under specification mirrors, uncertainty in the loss parameter)—it should therefore be possible to improve upon these. It is noted that the batch of cavities performs, without optimisation, to within 12% of the specified limit.

Considering now tapered cavity losses, the observed ring down time for spiced cavities 4.2 m long was 300±0.02 ns, which corresponds to a round-trip loss of 7.72×10⁻² or 7.7% (0.3 dB), Hence the fibre transmission, including the two splices and the taper is 0.9274.

Measurements with a high index liquid (1.51) show a drop in the ring down time of the cavity consistent with the presence of an evanescent field within the taper. The losses from the taper and the splices are clearly significant, more than was estimated from hie matching of the external diameters of the fibres, 0.04 dB. This figure produces an estimated loss, per round trip including a total of four passages through the splices, 3.6%, indicating the splicing and taper losses are larger than predicted.

We now examine some considerations for fibre optic sensor networks, first considering fibre cavity losses for tong cavities.

Extrapolating the loss analysis for non-tapered cavities, the fibre propagation losses dominate the cavity loss and hence it is possible to predict the losses of the cavity as a function of cavity length. For fibres with transmission losses of 7 dB km⁻¹, R=0.9995 the variation of ring-down time τ in microseconds with optical cavity length in metres is shown in FIG. 15. The ring down time, τ, increases by 26% from a 1 m cavity to a 100 m cavity. This strongly suggests that long fibre cavities may be deployed without significant loss of sensitivity and opens the potential for fibre optic cavity networks.

A fibre optic cavity may be fabricated with a broadband mirror. The ring down time and hence the sensitivity of fibre based e-CRDS is determined by the propagation losses in the fibre and the production of the taper. The losses in the fabrication of a single taper have yet to be determined but appears that the mirrors are not the limiting factor. This enables the reflectivity specification to be lowered to values around 0.999. Mirror production techniques allow the preparation of broadband very high reflectivity coatings over a wavelength region of at least 500-1000 nm. This enables radiation of different wavelengths to propagate along the same cavity, for example to interrogate different sensor regions.

Wavelength division multiplexing (WDM) in fibre optics is a well established technique in the telecoms industry and wdm coupler and switch technology can be employed to couple multiple wavelengths into a common cavity for parallel detection scenarios. For example switching of radiation of different colours, say red, green and blue, can be straightforwardly incorporated into a fibre network design, as shown schematically in the fibre sensor network 1600 of FIG. 16. Referring to FIG. 16, a fibre cavity 1602 includes one or more tapered regions to provide one or more evanescent wave sensing surfaces and hence a network of sensors. Light at a plurality of wavelengths, for example red, green and blue light from laser diodes or other sources, is coupled into the cavity by wdm light source 1604 and cavity ring-down is monitored by amplifier 1606, for example comprising a fibre amplifier, and console 1608. Console 1608 may comprise, for example, a wavelength division demultiplexer coupled to one or more PMTs (each) having a digitised output, these signals being provided to a computer programmed to determine cavity ring-down time at each of the wavelengths and hence to determine a (change in) cavity loss at the relevant wavelength (as described above) to provide a combined sensed signal/data output or plurality of sensed signal/data outputs. Console 1608 may also provide centralised monitoring/command/control of the sensor network.

Molecules absorbing at different wavelengths can be used to construct smart or functionalised surfaces either for monitoring the change of the same species or of different target species with the same cavity. For example haemoglobin has absorptions at 425 nm (due to the iron) and at 830 nm (due to the prophyrin ring) and can be used to functionalise a surface to sense oxygen, CO, and/or NO. In embodiments parallel detection of the same target using different functionalising molecules (absorbing at different wavelengths) allows measurements to be compared/combined, for example for increased confidence in detection or for a confidence limit assessment to be made. In one application a multiplexed fibre optic network of sensors working at different detection wavelengths is deployed in a public place or around (within) a building, vessel, or other structure. For example such a multiplexed sensor network may be used to monitor carbon dioxide level(s) in the air of a submarine.

We now consider the operation of free-running cavities, as described above, in more detail. As previously mentioned a free-running cavity structure allows a broad bandwidth cw laser to overlap with many cavity modes so that radiation will always enter the cavity. The observed ring down profile is then a convolution of the ring down of several modes each in principle with the own, slightly different τ. Each τ will depend on how flat the mirror reflectivity curve is over the bandwidth of the laser and whether there are any frequency dependent losses (e.g. diffraction losses) that are significantly different over the bandwidth of the laser. The free-running cavity allows the laser to be chopped at, for example, 10 kHz, which may be averaged to improve the noise statistics. With a stable cavity, the ring-down time shows a deviation error, Δτ/τ<1%, which determines the ultimate absorbance sensitivity of the fibre cavity technique.

The absorbance by a species in the cavity is related to the cavity length (the round-trip time) and the minimum detectable change in τ, the ring down time given by the formula:

$$Abs = \frac{Δ τ}{τ} \frac{{t}_{r}}{2 {τ}_{0}} \qquad ( 14 )$$

Work to date suggest that estimates of Δτ/τ are not generally better than 1% and the detection sensitivity is thus given by the round-trip time and τ of the empty cavity, τ₀. The minimum detectable absorbance for the fibre cavity, 1 m long, is 4.3×10⁻⁵ this provides a two-fold improvement in sensitivity compared with a bench top Dove cavity-with a minimum detectable absorbance limit of 7.4×10⁻⁵. The calculation for the fibre cavity assumes the observed ring-down time of 1.23 μs but this may be improved upon by optimising the fabrication.

We now consider cavity modes: The longitudinal modes of a cavity are dependent on the length of the cavity with the separation between the modes known as the free spectral range (FSR), as illustrated in FIG. 17. For a 2 m fibre cavity the FSR (n=1.4601):

$$\begin{matrix}δ v = \frac{n c}{2 I} \\ δ v = \frac{1.4601 \times 2.99 \times {10}^{8}}{4} = 109 MHz\end{matrix} \qquad ( 15 )$$

For a cavity 100 m long tile separation FSR becomes 2.1 kHz. The power intensity within a free-running cavity depends on the overlap of the input radiation with the cavity modes. The free-running cavity overlaps at least two modes, one FSR, and so light will always couple into the cavity. The output profile of a laser is generally rather broad, of order 5 nm, and so generally only a fraction this will couple to the cavity.

Coupling light into the cavity depends both oil the number of longitudinal modes overlapped by the input light source and the width of the modes. The full width half max (FWHM) of each mode is controlled by the cavity finesse as defined below.

Considering now cavity finesse and Q-factor, the width of the modes in FIG. 17 is controlled by the finesse of tile fibre cavity is given by:

$$F = \frac{π \sqrt{R}}{( 1 - R )} \qquad ( 16 )$$

For a 0.9995 cavity dominated by the mirror losses, the finesse of the cavity is 3140. If R is replaced by the general round trip loss for the fibre cavity, (0.9921) then the finesse of the fibre cavity is 396.

The Q-factor may be defined by equation 17 below, which for the fibre cavity takes the value 395.7—in close agreement with the calculated cavity finesse.

$$Q = \frac{2 π τ}{{t}_{r}} \qquad ( 17 )$$

From the relation Finesse=FSR/FWHM, the calculated FWHM for the modes in the fibre cavity is 275 kHz, and thus in a long cavity modes overlap to effectively provide a “white light” cavity into which light over a continuous range of wavelengths can be coupled.

In the configurations discussed above multimode fibres may be used as an alternative to single mode fibre, and a range of different index profiles may be employed to give a range of taper configurations. In some preparation processes tapers may be prepared in situ with a mirrored fibre so the losses can be monitored as the taper is pulled; this may be used to optimise the ring down time with the taper present in the cavity. Also, as mentioned, different taper thickness may be drawn to control the amount of evanescent field present outside the fibre and hence interaction with sensor molecules. Controlling the taper thickness can also be used to adjust the dynamic range of the sensor. Changing (increasing) the length of the taper changes (increases) the interaction length for the sensor surface and this can increase the sensitivity of a sensor. The networking potential for the sensors has been established, with cavity lengths of up to 100 m or more.

It appears that in some circumstances there is an advantage in moving to longer wavelengths to those used for the experiments described above. For example, increasing the detection wavelength from 639 nm to 820 nm or longer has the potential to reduce propagation losses within a fibre. Light sources are available at high power both at 820 nm and 1.5 μm, products of the telecommunications industry and the fibre transmission losses are generally much lower at 820 nm, ˜2 dB km⁻¹ giving ring down time for a 2 m cavity of 4.1 μs and a round trip transmission of 0.997. Thus loss is still dominated by tile fibres at 820 nm and the mirror losses do not need to be better than 0.999. At 1.5 μm the fibre losses are 0.18 dBkm⁻¹ and for a 2 m cavity give a cavity ring down time τ of 14.7 μs with a round trip transmission of 0.9993. Mirror reflectivity now becomes important and a cavity operating at this wavelength would preferably employ a 0.9995 or better mirror specification. At each wavelength the cavity parameters changes and the power and detection characteristics can be balanced by routine experiment. Calculation of the minimum detectable absorbance change using equation 14 suggests that the detection limit at 820 nm will be nearly 4 times better than at 639 nm and at 1.5 μm, some 10 times better than at 639 nm. Hence an 820 nm cavity will have a detection sensitivity of order 2×10⁻⁵. The skilled person will recognise that fibre optic e-CRDS will work within any fibre optic of tolerable transmission loss (of order 8 dB km⁻¹).

A longer wavelength than 639 nm, say ˜800 nm, may be used for example with a “dirty bomb” sensor surface as the molecule to which the target binds, isoamethyrin, (targets comprise actinyls such as UO₂²⁺, PuO₂²⁺, NpO₂²⁺) have an absorption maximum at approximately 830 inn. More generally a functionalising molecule may employ an extended porphyrin structure to tune the molecular electronics into this region of the spectrum. Liquid phase absorption spectra at 1.5 μm (6666 cm⁻¹) tend to be dominated by overtone absorptions but gas phase absorption occurs at these wavelengths, in particular CH₄ and CO₂, which may be employed for monitoring submarine environments. In a simple arrangement the target molecule is required to land on tile silica surface before detection, but the collision with the surface is directly proportional to the gas phase concentration. Longer wavelength radiation may also be employed with a suitable chromophore. For example, infrared chromophores tuned at 1.5 μm can be designed to allow the much lower transmission losses of silica at this wavelength to be exploited.

There are many other vibrations in the mid infrared which can be used, such as 1150 nm for the first overtone of the —CH₃ group in molecules and the 1400 nm —CH₂ combination band, which has been used the octane number of gasoline and which is of relevance to the petrochemical industry. The near IR and mid IR regions of the spectrum have potential for monitoring the properties of a collection of C, N, O, H species, for example for applications in industries such as the food and drink industry. Also, an e-CRDS sensitivity of order 10 ppm in absorbance offers potential for lower detection levels and tighter tolerances in the specification of aviation fuel.

The above described fibre optic-based or more generally waveguide-based CRDS systems may be employed to provide a range of sensor systems. Broadly speaking such sensor systems fall into two classes, intrinsic sensors based on losses in a fibre or a change in fibre properties in response to the surrounding environment, and extrinsic sensors (e-CRDS) where something is added to the surface of the fibre that will interact with a target or demonstrate an interaction with changing properties.

In general, in such a sensor system an output from a ring-down detector such as a PMT responsive to a light level within the cavity is digitised and provided to a signal processor such as a general purpose computer system, programmed in accordance with the above equations to determine a cavity ring-down time and hence a cavity loss. This information may be output directly (either as an output signal from the computer or as data written to a file or provided by a network connection) or further processing may be applied to determine a sensor signal representing, for example, a change in a sensed parameter such as a level of a target species present.

Depending upon the sensor configuration a wide range of information is available with this technique. For example, one or more intrinsic properties of a fibre used to form the cavity may be determined or, where a portion of a fibre included within the cavity is bent, changes in the cavity loss at the bend due to a change in say pressure, may be very sensitively monitored. In other arrangements the losses in the fibre may be sensitive to an external variable such as temperature or electric or magnetic field; in such arrangements it is often preferable that the fibre is doped to increase the desired sensing response. Where the light level detecting arrangement is able to resolve one or a group of individual light pulses bouncing to and fro within the cavity (for example using the Hammatsu H7732 photosensor module and fast oscilloscope mentioned above) then time-resolved sensing is possible with a very fine time granularity, for example better than 100 ns or better than 10 ns for a short cavity. Thus applications for the above described CRDS techniques include (but are not limited to) sensors to measure stress, strain, temperature, pressure, to act as hydrophone arrays, magnto-optic sensors, electro-optic sensors, flow sensors and displacement sensors. In addition to this a “smart” or functionalised sensor surface may be employed to provide chemical/biological sensors benefiting from the above described CRDS techniques.

We now further describe sensing using pulse train measurements.

In experiments with a free space cavity ring down using a pulsed laser, the decay of the intensity can be observed bounce-by-bounce. With the current losses in the 2 nm cavities, a light pulse makes approximately 190 round trips in the cavity during a 3τ-time period. This enables dispersion measurements to be made on the shape of the pulse and hence the accurate measure of dispersion in the fibre. For fast pulses the pulse shape may be determined by means of a streak camera (available, for example, from Hamamatsu), which allows the rise and fall times of the leading and trailing edges of the pulse to be determined as well as a level between the leading and trailing edges. Bounce-by-bounce measurements provide a calibrated time scale for dynamics measurements in solution phase chemistry. Moreover by simply varying the length of the cavity it is possible to monitor the progress of dynamics within the evanescent field on timescales of 19.5 ns for a 1 m cavity, 9.5 ns for a 1 m cavity and 90.5 ns for a 10 m cavity. One advantage over other dynamic measurement techniques is that the evanescent field is localised in the cavity and thus it is possible to monitor dynamics events with much greater certainty regarding the timescale.

We next describe some examples of intrinsic fibre optic or other waveguided sensors, where the chemical properties present within the fibre allow the environment of the fibre to be determined. In these sensors the sensing element comprises the fibre optic itself although one or more of a range of different materials may be incorporated within the glass making up the bulk of the fibre. Such materials may comprise, for example, rare-earth metals such as Erbium or Ytterbium.

We first describe an embodiment of a temperature sensor. Recent measurements on Er-doped fibres have shown a temperature dependent absorption at 840 and 860 nm. The absorption decreases at 840 nm with increasing temperature but increases at 860 nm. The ratio of these two absorbencies, determined absolutely by (e-)CRDS, and with great accuracy, can be used to measure temperature in the range 0-800° C.

We now describe an embodiment of a magnetic field sensor or magnetometer. Magneto-optic materials change their properties in response to magnetic field. The properties changing can be the refractive index properties or the response of the medium to different polarisations of the propagating radiation. For example, the presence of a magnetic field will change (rotate) the polarisation of the propagating radiation (the Faraday effect; a linear birefringence can also be induced in some systems) and this will change the propagation losses within the cavity. This can be detected by (e-)CRDS and with great sensitivity in a very simple system. Glass has a relatively small Verdet constant (describing tile degree of rotation) but a paramagnetic material such as terbium can be introduced within the fibre; this will show both a temperature dependence as well as the required Faraday effect. Presently fibre magneto-optic sensors require long path lengths to achieve a degree of sensitivity but CRDS technology enables the use of a short fibre cavity and can also provide the ability to make absolute measurements.

Similar techniques may be employed to provide an electric field sensor. For example work at the Optical Fibre Technology Centre, University of Sydney, Australia involves applying a very large electric field to silica then heating or irradiating it to induce an electro-optic effect. This technique can be used to make poled silica fibre exhibiting electro-optic behaviour. Alternatively an optical cavity may include a polymeric waveguide incorporating a non-linear or electro-optic material such as a chromophore with a high β value, providing the propagatin losses are low enough. Alternatively a high β chromophore may be deposited on the evanescent wave surface of, say, a tapered fibre, within the evanescent field to effectively provide an electro-optic response.

We next describe sensors for loss measurements for the fibre optic industry.

The fibre optics industry reports the losses of fibres in the units of dB km⁻¹, as in equation 6. For a fibre of length 1 km it is desirable to be able to measure the transmission loss to an accuracy of 0.0044 dB kmt⁻¹, a 1% determination in the transmitted power. As demonstrated above, using CRDS with the calculations shown, for 2 m length of fibre a loss of 0.00005 dB km⁻¹ is observable, an improvement of two orders of magnitude Preferably the mirrors are fabricated on the length of cable to be characterised.

It is also possible to determine fibre manipulation losses. In particular the above loss calculation, for tile example of a 2 m cavity, makes it possible to measure other losses in the fibre following specific manipulation. For a single splice in a fibre cavity it is potentially possible to measure loss with an accuracy of 0.00005 dB. Similar measurements are possible for bend losses to determine the bend radius of a fibre and taper losses.

In experiments with a free space cavity ring down using a pulsed laser, the decay of the intensity can be observed bounce-by-bounce. With the current losses in the 2 m cavities, a light pulse makes approximately 190 round trips in the cavity during a 3τ-time period. This enables dispersion measurements to be made on the shape of the pulse and hence the accurate measurement of dispersion in the fibre. For fast pulses the pulse shape may be determined by means of a streak camera (available, for example, from Hamamatsu), which allows the rise and fall times of the leading and trailing edges of the pulse to be determined as well as a level between the leading and trailing edges.

We finally describe some examples of fibre sensors based on the use of micro-bending detection, as suggested by FIG. 12.

A series of bends can be placed in a fibre, which depend on the environment of the fibre. Thus for example changing the temperature of the fibre causes it to increase its length and hence change the bending losses at the micro-bends, thus providing a temperature sensor.

A pressure measuring sensor may be implemented by means of a series of bends placed around a plate on which a fibre is mounted. These allow pressure to be sensed, for example to implement a microphone. The output from such a sensor may be used directly if the pressure modulations (frequency) are low, such as in tile blood or in a pressure vessel. Depending upon the frequency of operation, in a sound sensor or hydrophone the sound wave response may be deconvolved from that of the cavity as the human audible range is around 20 Hz-20 kHz and at the high end this is close to the ring-down time. The cavity should be excited at twice the maximum detection frequency to satisfy the Nyquist criterion. Embodiments of aspects of the invention provide a signal processor to extract a sound wave (or more generally vibration) sensor response from a cavity or other detector resonant response.

A similar CRDS fibre cavity may be used to implement a strain sensor. Thus a change in length of a fibre associated with a stress or a strain can be translated to a micro-bend either via a former or by placing part of the fibre directly on the surface of the stressed object. Broadly speaking the ability to sense/measure stress changes is limited only by the detection stability of the (e-)CRDS technique.

No doubt many effective variants will occur to the skilled person and it will be understood that the invention is not limited to the described embodiments but encompasses modifications apparent to those skilled in the art found within the spirit and scope of the appended claims.

Further Aspects of the Invention are Defined in the Following Clauses:

1. A waveguide-based cavity ring-down sensor for sensing an environmental variable, the sensor comprising:
an optical cavity including a waveguide;
a light source for exciting the optical cavity; and
a detector for monitoring a ring-down characteristic of the cavity; and
a signal processor coupled to said detector and configured to provide a signal output responsive to a change in optical propagation loss within said cavity as determined from said ring-down characteristic; and
wherein a change in said environmental variable causes a change in optical propagation loss in said waveguide to provide said signal output.

2. A sensor as defined in clause 1 wherein said waveguide comprises a fibre optic.

3. A fibre optic sensor as defined in clause 1 or 2 wherein said waveguide is doped to respond to said environmental variable.

4. A sensor as defined in clause 1, 2 or 3 wherein said environmental variable comprises one or more of temperature, magnetic field strength, and electric field strength.

5. A sensor as defined in clause 3 wherein said waveguide is doped with a paramagnetic material, and wherein said environmental variable comprises magnetic field strength.

6. A sensor as defined in clause 1, 2 or 3 wherein said light source is configured to excite said cavity at two different wavelengths, wherein said detector is configured to monitor ring-down characteristics of said cavity at said two different wavelengths, and wherein said signal processor is configured to provide said signal output responsive to said ring-down characteristics at said two different wavelengths.

7. A sensor as defined in clause 6 when dependent upon clause 3 wherein said waveguide is doped with Erbium, wherein said environmental variable comprises temperature, and wherein said wavelengths are selected such that said ring-down characteristics at said two different wavelengths vary in opposite senses vary a change in said temperature.

8. A wave guide-based sensing method for sensing an environmental variable using an optical cavity including a waveguide, the method comprising:
determining an optical ring-up or ring-down time for the cavity to determine a cavity loss; and
determining a change in said cavity loss from a change in said ring-up or ring-down time, said change in loss being caused by an effect of a change in said environmental variable on said waveguide, to sense said change in said environmental variable.

9. A method as defined in clause 8 wherein said waveguide is doped.

10. A method as defined in clause 8 or 9 further comprising determining said ring-up or ring-down time at two wavelengths, and determining said change in cavity loss at said two wavelengths to determine a change in said environmental variable.

11. A method as defined in clause 8, 9 or 10 wherein said environmental variable comprises one or more of temperature, magnetic field, and electric field.

Still Further Aspects of the Invention are Defined in the Following Clauses:

1. Fibre optic system characterising apparatus for characterising a fibre optic system using optical ring-down, the apparatus comprising:
an optical cavity configurable to include said fibre optic system;
a light source for exciting said cavity;
a detector for monitoring an optical ring-down of said cavity; and
a signal processor coupled to said detector and configured to determine a characteristic of said fibre optic system from said cavity optical ring-down.

2. Fibre optic system characterising apparatus as defined in clause 1 wherein said fibre optic system comprises a fibre optic cable.

3. Fibre optic system characterising apparatus as defined in clause 2 wherein at least one end of said fibre optic cable is provided with a mirror coating to form at least one end of said optical cavity.

4. Fibre optic system characterising apparatus as defined in clause 3 wherein both ends of said fibre optic cable are provided with a minor coating to from said optical cavity.

5. Fibre optic system characterising apparatus as defined in any one of clauses 1 to 4 wherein said fibre optic system characteristic comprises a transmission loss.

6. Fibre optic system characterising apparatus as defined in any one of clauses 1 to 4 wherein said fibre optic system characteristic comprises a measure of dispersion in the fibre optic system.

7. Fibre optic system characterising apparatus as defined in any preceding clause wherein said signal processor comprises a computer system including a processor and program memory, the program memory storing instructions to control the processor to input light level values from said detector, to determine a ring-down time for said cavity including said fibre optic system from said light level values, and to determine said fibre optic system characteristic using said ring-down time.

8. A carrier carrying the processor control instructions of clause 7.

9. A method of characterising a fibre optic system using optical ring-down, the method comprising:
forming an optical cavity including said fibre optic system;
exciting said optical cavity using a light source;
monitoring a ring-down of said cavity following said excitation; and
determining a characteristic of said fibre optic system from said monitoring.

10. A method as defined in clause 9 wherein said fibre optic system comprises a fibre optic cable.

11. A method as defined in clause 10 wherein said characteristic comprises a transmission loss.

12. A method as defined in clause 11 wherein said characterising comprises characterising a fibre manipulation loss, and wherein said optical cavity forming includes performing a manipulation on said fibre optic cable.

13. A method as defined in clause 11 wherein said manipulation comprises bending said fibre optic cable.

14. A method as defined in clause 11 wherein said manipulation comprises tapering said fibre optic cable.

15. A method as defined in clause 9 or 10 wherein said characteristic comprises a measure of dispersion in said fibre optic system.

Still Further Aspects of the Invention are Defined in the Following Clauses:

1. A fibre optic sensor, the sensor comprising:
an optical cavity including a fibre optic;
a light source for exciting the optical cavity; and
a detector for monitoring a ring-down characteristic of the cavity; and
wherein said fibre optic is configured such that a change in a sensed variable causes a physical change in said fibre optic configuration modifying said ring-down characteristic.

2. A fibre optic sensor as defined in clause 1 wherein said fibre optic configuration includes one or more bends.

3. A fibre optic sensor as defined in clause 1 or 2 wherein said fibre optic is mounted on a support to sense pressure.

4. A fibre optic sensor as defined in clause 1 or 2 wherein said physical change in fibre optic configuration comprises a change in length of said fibre optic.

5. A fibre optic sensor as defined in clause 4 wherein said change in length causes a distortion of said fibre optic.

6. A fibre optic sensor as defined in clause 4 or 5 wherein said fibre optic sensor is configured as a stress or strain sensor.

7. A fibre optic sensor as defined in clause 4 or 5 where in said fibre optic sensor is configured to sense temperature.

8. A fibre optic sensor as defined in any preceding clause further comprising a signal processor coupled to said detector and configured to provide a sensed variable output by determining a ring-down time of said cavity.

9. A method of sensing using distortion of a fibre optic, the fibre optic comprising at least part of an optical cavity, the method comprising:
determining an optical ring-up or ring-down time of said cavity;
distorting said fibre optic with a sensed variable; and
determining a change in said ring-up or ring-down tin-Le to sense said distortion.

10. A method as defined in clause 9 wherein said fibre optic is bent.

11. A method as defined in clause 9 or 10 wherein said distorting includes changing a length of said fibre optic.

12. A method as defined in clause 9, 10 or 11 wherein said sensed variable comprises one or more of temperature, pressure, stress and strain.

In all of the above described apparatus, sensors and methods (of all the sets of clauses) a light source may be configured to excite the cavity at two different wavelengths, tile detector being configured to monitor ring-down characteristics of the cavity simultaneously at said two different wavelengths, for improved performance. In embodiments the apparatus may be configured to provide a differential signal. A signal processor may also be provided, configured to provide a signal output responsive to the ring-down characteristics at the two different wavelengths.

1-58. (canceled)

59. An evanescent wave cavity-based optical sensor, the sensor comprising:
an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function;
a light source to inject a pulse of light into said cavity;
a detector to detect decaying oscillations of said light pulse within said cavity; and
a signal processor coupled to said detector and configured to provide a time-resolved output responsive to a light level within said cavity and having a time-resolution corresponding to a set of said light pulse oscillations, whereby said sensing function operates at substantially said time-resolution.

60. An optical sensor as claimed in claim 59 wherein said set of light pulse oscillations comprises a single said light pulse or a pair of said pulses.

61. An optical sensor as claimed in claim 59 wherein said TIR surface is provided with a functionalising material over at least part of said TIR surface such that said evanescent wave interacts with said material;
whereby an interaction between said functionalising material and a target to be sensed is detectable as a change in absorption of said evanescent wave.

62. An optical sensor as claimed in claim 59 wherein said TIR surface is provided with an electrically conducting material over at least part of said TIR surface such that said evanescent wave excites a surface plasmon within said material;
whereby a change in absorption of said evanescent wave due to a change in said surface plasmon excitation is detectable using said detector to provide said sensing function.

63. An optical sensor as claimed in claim 59 wherein said optical cavity comprises a fibre optic sensor configured to provide an evanescent field from light guided within the fibre.

64. An optical sensor as claimed in claim 59 wherein said time-resolution is substantially determined by a length of said optical cavity.

65. A method of performing time-resolved sensing using an optical cavity including a sensing surface, a sensing interaction at said sensing surface modifying an optical ring-down characteristic of said cavity, the method comprising:
injecting a pulse of light into said cavity; and
monitoring an optical ring-down of said pulse within said cavity to monitor said sensing interaction; and
wherein said monitoring is performed substantially on a pulse-by-pulse basis such that said sensing is time-resolved at a resolution of at least an integral number of round trip times of said cavity.

66. A method as claimed in claim 65 wherein said integral number of round trip times is one.

67. A method as claimed in claim 65 further comprising selecting said time resolution by selecting a length of said cavity.

68. An evanescent-wave cavity-based optical sensor system, the system comprising:
an optical cavity formed by a pair of highly reflective surfaces such that light within said cavity makes a plurality of passes between said surfaces, an optical path between said surfaces including a reflection from one or more totally internally reflecting (TIR) surfaces, a said reflection from a TIR surface generating an evanescent wave to provide an attenuated TIR sensing function;
a light source to optically excite said cavity at least two different wavelengths; and
a detector to monitor a ring-down characteristic of said cavity at each of said two wavelengths; and
wherein said one or more TIR surfaces are provided with at least two functionalising materials one responsive at each of said wavelengths such that an interaction between a said functionalising material and one or more targets to be sensed is detectable as a change in absorption of a said evanescent wave at a said wavelength.

69. A sensor system as claimed in claim 68 wherein said two functionalising materials comprise different materials selected to detect a common said target.

70. A sensor system as claimed in claim 69 further comprising a signal processor coupled to said detector and configured to provide an output signal indicative of said target from a combination of said ring-down characteristic at said two wavelengths.

71. A sensor system as claimed in claim 69 wherein a said TIR surface is provided with both said functionalising materials.

72. A sensor system as claimed in claim 69 wherein said optical cavity includes at least two said TIR surfaces, and wherein a first of said TIR surfaces is provided with a first of said functionalising materials and a second of said TIR surfaces is provided with a second of said functionalising materials.

73. A sensor system as claimed in claim 68 wherein said optical cavity includes a fibre optic configured to provide said one or more TIR surfaces.

74. A sensor system as claimed in any one of claim 68 wherein said cavity has a length of at least 5 metres, 10 metres, or 50 metres.

75. A method of wavelength division multiplexing sensors of an evanescent wave cavity ring-down sensor system, the method comprising:
applying a plurality of different functionalising materials to one or more evanescent wave sensing regions of a cavity of said sensor system, said different functionalising materials having sensing responses at different wavelengths;
exciting said cavity at a plurality of different wavelengths corresponding to wavelengths of said sensing responses of said functionalising materials; and
monitoring a ring-down characteristic of said cavity at each of said exciting wavelengths.

76. A waveguide-based cavity ring-down sensor for sensing an environmental variable, the sensor comprising:
an optical cavity including a waveguide;
a light source for exciting the optical cavity; and
a detector for monitoring a ring-down characteristic of the cavity; and
a signal processor coupled to said detector and configured to provide a signal output responsive to a change in optical propagation loss within said cavity as determined from said ring-down characteristic; and
wherein a change in said environmental variable causes a change in optical propagation loss in said waveguide to provide said signal output.

77. A sensor as claimed in claim 76 wherein said waveguide comprises a fibre optic.

78. A fibre optic sensor as claimed in claim 76 wherein said waveguide is doped to respond to said environmental variable.

79. A sensor as claimed in claim 76 wherein said environmental variable comprises one or more of temperature, magnetic field strength, and electric field strength.

80. A sensor as claimed in claim 79 wherein said waveguide is doped with a paramagnetic material, and wherein said environmental variable comprises magnetic field strength.

81. A sensor as claimed in claim 76 wherein said light source is configured to excite said cavity at two different wavelengths simultaneously, wherein said detector is configured to monitor ring-down characteristics of said cavity at said two different wavelengths, and wherein said signal processor is configured to provide said signal output responsive to said ring-down characteristics at said two different wavelengths.

82. A sensor as claimed in claim 81 wherein said waveguide is doped with Erbium to respond to said environmental variable, wherein said environmental variable comprises temperature, and wherein said wavelengths are selected such that said ring-down characteristics at said two different wavelengths vary in opposite senses with a change in said temperature.

83. A waveguide-based sensing method for sensing an environmental variable using an optical cavity including a waveguide, the method comprising:
determining an optical ring-up or ring-down time for the cavity to determine a cavity loss; and
determining a change in said cavity loss from a change in said ring-up or ring-down time, said change in loss being caused by an effect of a change in said environmental variable on said waveguide, to sense said change in said environmental variable.

84. A method as claimed in claim 83 wherein said waveguide is doped.

85. A method as claimed in claim 83 further comprising determining said ring-up or ring-down time at two wavelengths, and determining said change in cavity loss at said two wavelengths to determine a change in said environmental variable.

86. A method as claimed in claim 83 wherein said environmental variable comprises one or more of temperature, magnetic field, and electric field.

87. Fibre optic system characterising apparatus for characterising a fibre optic system using optical ring-down, the apparatus comprising:
an optical cavity configurable to include said fibre optic system;
a light source for exciting said cavity;
a detector for monitoring an optical ring-down of said cavity; and
a signal processor coupled to said detector and configured to determine a characteristic of said fibre optic system from said cavity optical ring-down.

88. Fibre optic system characterising apparatus as claimed in claim 87 wherein said fibre optic system comprises a fibre optic cable.

89. Fibre optic system characterising apparatus as claimed in claim 88 wherein at least one end of said fibre optic cable is provided with a mirror coating to form at least one end of said optical cavity.

90. Fibre optic system characterising apparatus as claimed in claim 89 wherein both ends of said fibre optic cable are provided with a mirror coating to form said optical cavity.

91. Fibre optic system characterising apparatus as claimed in claim 87 wherein said fibre optic system characteristic comprises a transmission loss.

92. Fibre optic system characterising apparatus as claimed in claim 87 wherein said fibre optic system characteristic comprises a measure of dispersion in the fibre optic system.

93. Fibre optic system characterising apparatus as claimed in claim 87 wherein said signal processor comprises a computer system including a processor and program memory, the program memory storing instructions to control the processor to input light level values from said detector, to determine a ring-down time for said cavity including said fibre optic system from said light level values, and to determine said fibre optic system characteristic using said ring-down time.

94. A carrier carrying the processor control instructions of claim 93.

95. A method of characterising a fibre optic system using optical ring-down, the method comprising:
forming an optical cavity including said fibre optic system;
exciting said optical cavity using a light source;
monitoring a ring-down of said cavity following said excitation; and
determining a characteristic of said fibre optic system from said monitoring.

96. A method as claimed in claim 95 wherein said fibre optic system comprises a fibre optic cable.

97. A method as claimed in claim 96 wherein said characteristic comprises a transmission loss.

98. A method as claimed in claim 97 wherein said characterising comprises characterising a fibre manipulation loss, and wherein said optical cavity forming includes performing a manipulation on said fibre optic cable.

99. A method as claimed in claim 98 wherein said manipulation comprises bending or tapering said fibre optic cable.

100. A method as claimed in claim 95 wherein said characteristic comprises a measure of dispersion in said fibre optic system.

101. A method as claimed in claim 95 wherein said monitoring comprises monitoring at a plurality of wavelengths simultaneously.

102. A fibre optic sensor, the sensor comprising:
an optical cavity including a fibre optic;
a light source for exciting the optical cavity; and
a detector for monitoring a ring-down characteristic of the cavity; and
wherein said fibre optic is configured such that a change in a sensed variable causes a physical change in said fibre optic configuration modifying said ring-down characteristic.

103. A fibre optic sensor as claimed in claim 102 wherein said fibre optic configuration includes one or more bends.

104. A fibre optic sensor as claimed in claim 102 wherein said fibre optic is mounted on a pressure-responsive support structure to sense pressure.

105. A fibre optic sensor as claimed in claim 102 wherein said physical change in fibre optic configuration comprises a change in length of said fibre optic.

106. A fibre optic sensor as claimed in claim 105 wherein said change in length causes a distortion of said fibre optic.

107. A fibre optic sensor as claimed in claim 105 wherein said fibre optic sensor is configured to sense one or more of stress, strain and temperature.

108. A fibre optic sensor as claimed in claims 102 further comprising a signal processor coupled to said detector and configured to provide a sensed variable output by determining a ring-down time of said cavity.

109. A fibre optic sensor as claimed in claim 108 configured to provide said sensed variable output responsive to signals sensed simultaneously at a plurality of wavelengths.

110. A method of sensing using distortion of a fibre optic, the fibre optic comprising at least part of an optical cavity, the method comprising:
determining an optical ring-up or ring-down time of said cavity;
distorting said fibre optic with a sensed variable; and
determining a change in said ring-up or ring-down time to sense said distortion.

111. A method as claimed in claim 110 wherein said fibre optic is bent.

112. A method as claimed in claim 110 wherein said distorting includes changing a length of said fibre optic.

113. A method as claimed in claim 110 wherein said sensed variable comprises one or more of temperature, pressure, stress and strain.

114. An evanescent-wave cavity-ring down sensing system, the system comprising:
an evanescent-wave optical cavity;
an optical pump to provide a pump pulse to said optical cavity at a first wavelength; and
an optical probe to provide a probe pulse to said optical cavity at a second wavelength.

115. A sensing system as claimed in claim 114 comprising at least one pulsed illumination source to provide said pump and probe pulses.

116. A sensing system as claimed in claim 115 wherein at least one of said pump pulse and said probe pulse is shorter than an optical round trip time of said cavity.

117. A sensing system as claimed in claim 114 wherein a loss of said optical cavity at said first wavelength is such that said pump pulse makes substantially only a single pass of said optical cavity.
